(19) United States
(12) Patent Application Publication
(10) Pub. No.: US 2022/0380660 A1
(43) Pub. Date: Dec. 1, 2022

(54) IN SITU UPGRADING OF HEAVY HYDROCARBON USING ONE OR MORE DEGRADABLE SOLVENTS AND ONE OR MORE ADDITIVES

(71) Applicant: CHEVRON U.S.A. INC., San Ramon, CA (US)

(72) Inventors: Jeffrey M. WOOLFORD, Bakersfield, CA (US); Cesar OVALLES, Walnut Creek, CA (US); Babak FAYYAZ-NAJAFI, Alamo, CA (US); Ian P. BENSON, The Woodlands, TX (US); Juan D. MUNOZ, Bakersfield, CA (US)

(73) Assignee: CHEVRON U.S.A. INC., San Ramon, CA (US)

(21) Appl. No.: 17/751,950

(22) Filed: May 24, 2022

Related U.S. Application Data
(60) Provisional application No. 63/194,650, filed on May 28, 2021.

(51) Int. Cl. C09K 8/594; C09K 8/584; E21B 43/16

(52) U.S. Cl. CPC C09K 8/594; C09K 8/584; E21B 43/164; E21B 43/168

(57) ABSTRACT

Embodiments are provided herein for in situ upgrading of a heavy hydrocarbon in a reservoir having an injection well and a production well, or a well that is alternately operated as an injection well and a production well. Embodiments are also provided herein for selecting a degradable solvent for use in a process for in situ upgrading of a heavy hydrocarbon in a reservoir having an injection well and a production well, or a well that is alternately operated as an injection well and a production well.

### CROSS REFERENCES TO RELATED APPLICATIONS

This application claims the benefit of priority to U.S. Provisional Application No. 63/194,650, filed May 28, 2021, which is incorporated by reference herein in its entirety.

### TECHNICAL FIELD

The present disclosure generally relates to a process for in situ upgrading of a heavy hydrocarbon in a reservoir.

### BACKGROUND

One technique for extracting hydrocarbon from a hydrocarbon bearing reservoir involves the drilling of a well into the reservoir and pumping the hydrocarbon out. In many cases, however, the hydrocarbon is too viscous under the reservoir conditions, and thus adequate hydrocarbon flow rates cannot be achieved with this technique.

Enhanced oil recovery (EOR) techniques have been developed to improve the hydrocarbon flow rate. One example of an enhanced oil recovery technique involves the injection of steam into the hydrocarbon bearing reservoirs, such as reservoirs containing heavy oil (also referred to as heavy hydrocarbon). The steam increases the temperature of the hydrocarbon and reduces the hydrocarbon's viscosity. The hydrocarbon can then be pumped from the reservoir with an improved hydrocarbon flow rate.

It would be desirable to provide improved processes for addressing heavy hydrocarbon.

### SUMMARY

Embodiments are provided herein for in situ upgrading of a heavy hydrocarbon in a reservoir having an injection well and a production well, or a well that is alternately operated as an injection well and a production well.

In one aspect, the disclosure can generally relate to a method for in situ upgrading of a heavy hydrocarbon in a reservoir having an injection well and a production well, or a well that is alternately operated as an injection well and a production well. The method includes injecting one or more degradable solvents and one or more additives into the injection well in the reservoir comprising the heavy hydrocarbon so as to form a blend in the reservoir that includes an upgraded hydrocarbon. The upgraded hydrocarbon has an API gravity greater than an initial API gravity of the heavy hydrocarbon and a viscosity lower than an initial viscosity of the heavy hydrocarbon. The one or more additives include one or more detergents, one or more demulsifiers, one or more scavengers, one or more biocides, or any combination thereof.

In one aspect, the disclosure can generally relate to a method for selecting a degradable solvent for use in a process for in situ upgrading of a heavy hydrocarbon in a reservoir having an injection well and a production well, or a well that is alternately operated as an injection well and a production well. The method includes selecting the degradable solvent for injection into the reservoir, and the selected degradable solvent satisfies the following criteria: (a) an aromatic content of from less than 1% wt./wt. as measured by ASTM D6591-19, and (b) an asphaltene stability P-value of from 1.2 or more as measured by ASTM D6703-19.

### DESCRIPTION OF THE DRAWINGS

FIG. 1 is a schematic diagram for the process for in situ upgrading of a heavy hydrocarbon via co-injection of one or more degradable solvents and one or more additives.

FIG. 2 is a schematic diagram for the process for in situ upgrading of a heavy hydrocarbon via injection of one or more additives before injection of one or more degradable solvents.

FIG. 3 is a schematic diagram for the process for in situ upgrading of a heavy hydrocarbon via injection of one or more degradable solvents before injection of one or more additives.

FIG. 4 is a schematic diagram for the process for in situ upgrading of a heavy hydrocarbon via injection of a pre-mixed mixture comprising one or more degradable solvents and one or more additives.

FIG. 5 is a schematic diagram for the process for in situ upgrading of a heavy hydrocarbon with recycling. In FIG. 5, recycling includes removing at least a portion of the upgraded hydrocarbon from the produced blend and injecting the removed upgraded hydrocarbon into the injection well.

FIG. 6 is a schematic diagram for the process for in situ upgrading of a heavy hydrocarbon with recycling. In FIG. 6, recycling includes removing at least a portion of the one or more degradable solvents from the produced blend and injecting the removed one or more degradable solvents into the injection well.

FIG. 7 is another schematic diagram for the process for in situ upgrading of a heavy hydrocarbon with recycling. In FIG. 7, recycling includes removing at least a portion of the one or more degradable solvents from the produced blend and injecting the removed one or more degradable solvents into the injection well.

FIG. 8 is a schematic diagram for the process for in situ upgrading of a heavy hydrocarbon via co-injection of one or more degradable solvents, one or more additives, and steam.

FIG. 9 is a diagram for the process for in situ upgrading of a heavy hydrocarbon via injection of one or more degradable solvents and one or more additives using a SAGD configuration.

FIG. 10 is a diagram for the process for in situ upgrading of a heavy hydrocarbon via injection of one or more degradable solvents and one or more additives using a flooding configuration.

FIG. 11 illustrates the effect of the degradable solvent d-limonene on the API gravity of Crude Oil 1.

FIG. 12 illustrates the effect of the degradable solvent beta-pinene on the API gravity of Crude Oil 1.

FIG. 13 illustrates the effect of the degradable solvent d-limonene on the viscosity of Crude Oil 1.

FIG. 14 illustrates the effect of the degradable solvent beta-pinene on the viscosity of Crude Oil 1.

FIG. 15 illustrates the effect of the degradable solvent d-limonene on the viscosity of Crude Oil 2.

FIG. 16 illustrates the effect of the degradable solvent beta-pinene on the viscosity of Crude Oil 2.

FIG. 17A illustrates the effect of additives on the viscosity of degradable solvents and Crude Oil 1. FIG. 17B illustrates the effect of additives on the viscosity of degradable solvents and Crude Oil 2.

FIG. 18A illustrates simulated cumulative oil production for Crude Oil 1 after cyclic beta-pinene injection. FIG. 18B illustrates simulated Crude Oil 1 to beta-pinene ratios for cyclic solvent injection with and without methane co-injection.

FIG. 19A illustrates simulated cumulative oil production for Crude Oil 1 after beta-pinene flooding. FIG. 19B illustrates simulated Crude Oil 1 to beta-pinene ratios for solvent flooding with and without methane co-injection.

FIG. 20A illustrates the effect of the degradable solvent d-limonene on the asphaltenes of Crude Oil 1 in laboratory experiments. FIG. 20B illustrates the effect of the degradable solvent beta-pinene on the asphaltenes of Crude Oil 1 in laboratory experiments.

FIG. 21 is an image from one of the laboratory experiments illustrating that the asphaltenes are stable in solution.

Reference will now be made in detail to various embodiments, where like reference numerals designate corresponding parts throughout the several views. In the following detailed description, numerous specific details are set forth in order to provide a thorough understanding of the present disclosure and the embodiments described herein. But it will be apparent to one of ordinary skill in the art that the subject matter may be practiced without these specific details. In other instances, well-known methods, procedures, components, etc. have not been described in detail so as not to unnecessarily obscure aspects of the embodiments.

### DETAILED DESCRIPTION

TERMINOLOGY: The following terms will be used throughout the specification and will have the following meanings unless otherwise indicated.

The following ASTM standards are incorporated by reference:

ASTM D6591-19 - Standard Test Method for Determination of Aromatic
Hydrocarbon Types in Middle Distillates - High-Performance Liquid
Chromatography Method with Refractive Index Detection - available
at https://www.astm.org/Standards/D6591.htm
ASTM D6703-19 - Standard Test Method for Automated Heithaus
Titrimetry - available at https://www.astm.org/Standards/D6703.htm
ASTM D6139-18 - Standard Test Method for Determining the Aerobic
Aquatic Biodegradation of Lubricants or Their Components Using
the Gledhill Shake Flask - available at
https://www.astm.org/Standards/D6139.htm
ASTM D5864-18 - Standard Test Method for Determining Aerobic
Aquatic Biodegradation of Lubricants or Their Components -
available at https://www.astm.org/Standards/D5864.htm
ASTM D6731-18 - Standard Test Method for Determining the Aerobic,
Aquatic Biodegradability of Lubricants or Lubricant Components in
a Closed Respirometer - available at
https://www.astm.org/Standards/D6731.htm
ASTM D4052-18a - Standard Test Method for Density, Relative Density,
and API Gravity of Liquids by Digital Density Meter - available at
https://www.astm.org/Standards/D4052.htm
ASTM D445-19a - Standard Test Method for Kinematic Viscosity of
Transparent and Opaque Liquids (and Calculation of Dynamic
Viscosity) - available at https://www.astm.org/Standards/D445.htm
ASTM D6560-17 - Standard Test Method for Determination of
Asphaltenes (Heptane Insolubles) in Crude Petroleum and Petroleum
Products - available at https://www.astm.org/Standards/D6560.htm

“Heavy hydrocarbon,” in general, is an asphaltene-containing liquid crude hydrocarbon. Asphaltenes are a mixed solubility class of compounds as opposed to a chemical class of compounds, are generally solid or semi-solid in nature and include polynuclear aromatics present in the solution of smaller aromatics and resin molecules, and are present in crude oils and heavy fractions in varying quantities. Asphaltenes do not usually exist in all condensates or light crude oils; however, they are present in relatively large quantities in heavy crude oils and petroleum fractions. Asphaltenes are insoluble components or fractions and their concentrations are defined as the amount of asphaltenes precipitated by addition of an n-paraffin solvent to the feedstock which are completely soluble in aromatic solvents, as prescribed in the Institute of Petroleum Method IP-143. The heavy hydrocarbon can contain a heavy crude oil, an extra heavy crude oil and/or bitumen.

In one embodiment, the heavy hydrocarbon has an initial API gravity of from about 5 to about 20, an n-heptane asphaltene content as measured by the ASTM D-6560-17 of at least about 1 wt. % and up to about 15 wt. %, and a viscosity (at 40° C. or 100° C.) greater than about 20 cSt and up to about 100,000 cSt. In one embodiment, the heavy hydrocarbon has an initial API gravity of from about 8 to about 20, an n-heptane asphaltene content as measured by the ASTM D-6560-17 of at least about 1 wt. % and up to about 10 wt. %, and a viscosity (at 40° C. or 100° C.) greater than about 20 cSt and up to about 30,000 cSt. The viscosity measurements are determined herein according to ASTM D445-19a. The API gravity measurements are determined herein according to ASTM D4052-18a. In one embodiment, the hydrocarbon that is recovered from the heavy hydrocarbon-bearing reservoir, typically flows slowly, if at all, during production. In one embodiment, the heavy hydrocarbon is solid at the temperature and the pressure of the hydrocarbon-bearing reservoir. The hydrocarbon that is produced from the heavy hydrocarbon-bearing reservoir may range from light to extra heavy crude oil.

According to the American Petroleum Institute (API) gravity scale, light crude oil is defined as having an API gravity greater than 31.1° API (less than 870 kg/m3), medium crude oil is defined as having an API gravity between 22.3° API and 31.1° API (870 to 920 kg/m3), heavy crude oil is defined as having an API gravity between 10.0° API and 22.3° API (920 to 1000 kg/m3), and extra heavy crude oil is defined with API gravity below 10.0° API (greater than 1000 kg/m3).

“Hydrocarbon bearing reservoir” or “reservoir” (also referred to as hydrocarbon bearing formation or formation) is a geological, subsurface reservoir in which hydrocarbons occur and from which they may be produced. As discussed herein, one or more degradable solvents and one or more additives may be suitable for enhancing hydrocarbon recovery from a hydrocarbon bearing reservoir, especially reservoirs containing heavy hydrocarbon.

“In situ” refers to within the subterranean reservoir. In situ upgrading is any underground, subsurface, or downhole processes of heavy hydrocarbon that leads to changes in the physical and chemical properties of these materials. In this way, higher production rates and improved recovery of heavy hydrocarbon can be obtained.

“Asphaltenes” are a solubility class of compounds and are arbitrarily defined as the fraction of petroleum insoluble in light alkanes (C3-C7) but soluble in aromatic (benzene, toluene, etc.) solvents. More information about asphaltenes may be found in Martha L. Chacón-Patiño, et al., Vanadium and nickel distributions in Pentane, In-between C5-C7 Asphaltenes, and heptane asphaltenes of heavy crude oils, Fuel, Volume 292, 2021, 120259, which is incorporated by reference.

Reference is made to locations relative to the earth's “surface.” It will be understood that any reference to the earth's surface is to be interpreted in general terms. The reference surface for a land-based installation is the land surface. The reference surface for a water-based installation is the water surface, seafloor, or any combination thereof.

“Surface facility” as used herein is any structure, device, means, service, resource or feature that occurs, exists, takes place or is supported on the surface of the earth.

“Ambient conditions” are the natural temperature and pressure at the earth's surface. For example, ambient conditions are characterized by a temperature of 20° C. and a pressure of 1 atm (101 kPa).

“Reservoir conditions” include a reservoir temperature. The reservoir conditions may also include a reservoir pressure. The reservoir temperature is the temperature of the reservoir. The reservoir pressure is the pressure of the reservoir. The reservoir temperature may be 30° C. to 200° C. If steam injection is anticipated, then the reservoir temperature may be steam temperature up to 300° C. The reservoir pressure may be 10 psi to 15,000 psi. The reservoir pressure may be of from 10 psi to 50 psi above reservoir pressure in another embodiment. The reservoir conditions may also include the native biota found in the reservoir.

“Well” (also referred to as wellbore, well bore, or borehole) refers to a single hole, usually cylindrical, that is drilled into the reservoir for hydrocarbon exploration, hydrocarbon recovery (also referred to as hydrocarbon production), surveillance, or any combination thereof. The well is usually surrounded by the reservoir and the well may be configured to be in fluidic communication with the reservoir. The well may also be configured to be in fluidic communication with the surface, such as in fluidic communication with a surface facility that may include separation equipment, storage tanks, pumps, gauges, meters, sensors, pipelines, etc.

The well may be used for injection (sometimes referred to as an injection well) in some embodiments. The well may be used for production (sometimes referred to as a production well) in some embodiments. The well may be used for a single function, such as only injection, in some embodiments. The well may be used for a plurality of functions, such as injection and production. As discussed herein, embodiments are provided for in situ upgrading of a heavy hydrocarbon in a reservoir having an injection well and a production well, or a well that is alternately operated as an injection well and a production well. A plurality of wells (e.g., tens to hundreds of wells) are often used in a field to recover hydrocarbons. As described herein, one or more wells may be utilized for cyclic solvent injection or solvent flooding.

A well may be drilled in one or more directions. For example, a well may include a vertical well, a horizontal well, a deviated well, and/or other type of well. A well may be drilled in the reservoir for exploration and/or recovery of hydrocarbon. A well may be drilled into the reservoir using practically any drilling technique and equipment known in the art, such as geosteering, directional drilling, etc. The term “well” is not limited to any description or configuration described herein.

Other definitions: The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

IN SITU UPGRADING: Embodiments are provided herein for in situ upgrading of a heavy hydrocarbon in a reservoir. In one aspect, the disclosure can generally relate to a method for in situ upgrading of a heavy hydrocarbon in a reservoir having an injection well and a production well, or a well that is alternately operated as an injection well and a production well. The method includes injecting one or more degradable solvents and one or more additives into the injection well in the reservoir comprising the heavy hydrocarbon so as to form a blend in the reservoir that includes an upgraded hydrocarbon. The upgraded hydrocarbon has an API gravity greater than an initial API gravity of the heavy hydrocarbon (e.g., as measured by ASTM D4052-18a) and a viscosity lower than an initial viscosity of the heavy hydrocarbon (e.g., as measured by ASTM D445-19a). The one or more additives include one or more detergents, one or more demulsifiers, one or more scavengers, one or more biocides, or any combination thereof. The method may also include producing the blend comprising the upgraded hydrocarbon from the production well.

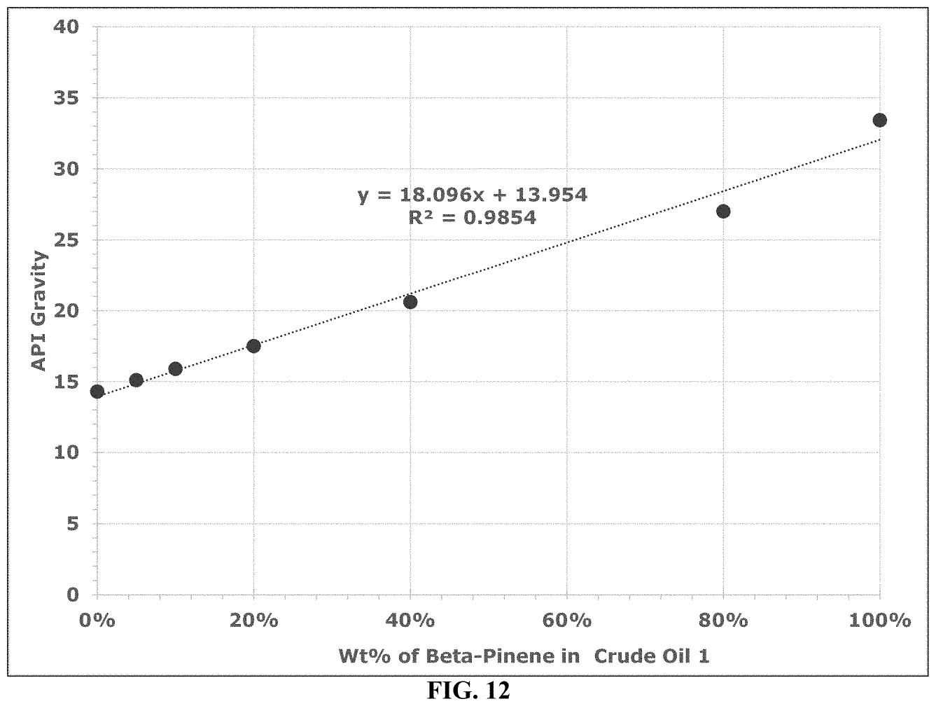

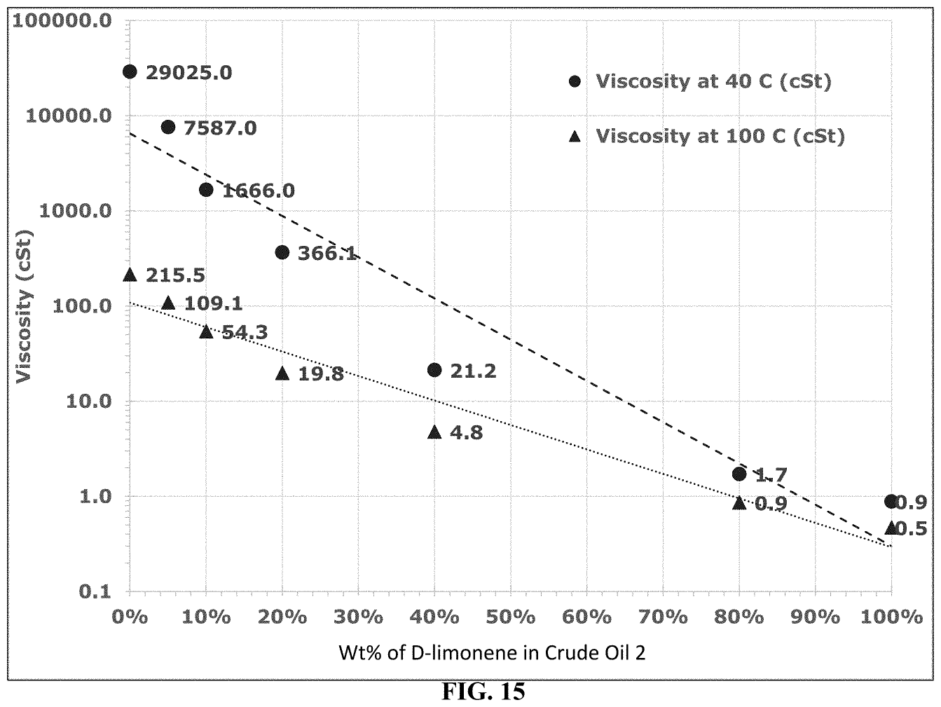

Advantageously, the one or more degradable solvents and the one or more additives may be injected for in situ upgrading of the heavy hydrocarbon in the reservoir to enhanced oil recovery (EOR) of the heavy hydrocarbon. After injection, the one or more degradable solvents may decrease the viscosity and increase the API gravity of the heavy hydrocarbon to increase the production rate. After injection, the one or more additives protect the one or more degradable solvents downhole, reduce or prevent obstructions in the reservoir from debris and dust particles, etc. As an example, the upgraded hydrocarbon may have a minimum of 17 API vs. an original API of about 14 API (see FIG. 12), and two- to three-fold reduction of viscosity making it transportable using pipelines (e.g., a viscosity of about 366 cSt at 40° C. vs. an original viscosity of 29,025 cSt at 40° C., see FIG. 15) without steam injection and expensive surface upgrader facilities.

Indeed, advantageously, the one or more degradable solvents and the one or more additives may improve hydrocarbon recovery without conventional steam injection. For example, the one or more degradable solvents may be injected at reservoir temperature and/or may be injected in a warmed state (e.g., temperature <200° C.) without the use of conventional steam injection. Some conventional steam injection approaches use natural gas burning steam generators. However, the one or more degradable solvents and the one or more additives may be utilized to enhance oil recovery of heavy hydrocarbon, and the natural gas burning steam generators may be idled. Each idled natural gas burning steam generator would avoid burning natural gas and avoid producing the associated carbon dioxide, nitrogen oxides, and carbon monoxide. Even if some conventional steam injection is utilized with the one or more degradable solvents and the one or more additives, then less conventional steam injection may be utilized (e.g., 10% to 50% less conventional steam injection) in accordance with the embodiments provided herein. In short, conventional steam injection may be eliminated or substantially reduced while improving hydrocarbon production from heavy hydrocarbon bearing reservoirs in accordance with the embodiments provided herein, especially for deep, high-pressure heavy hydrocarbon bearing reservoirs.

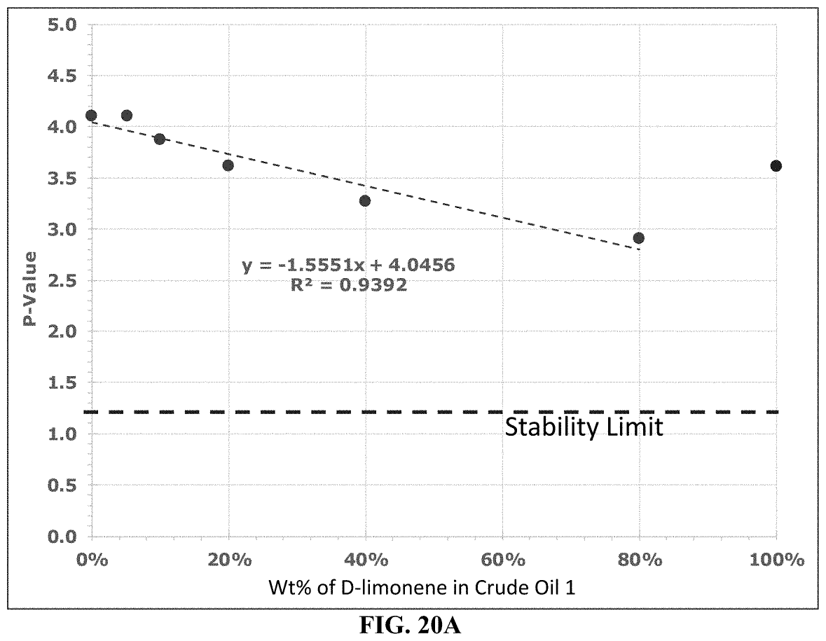

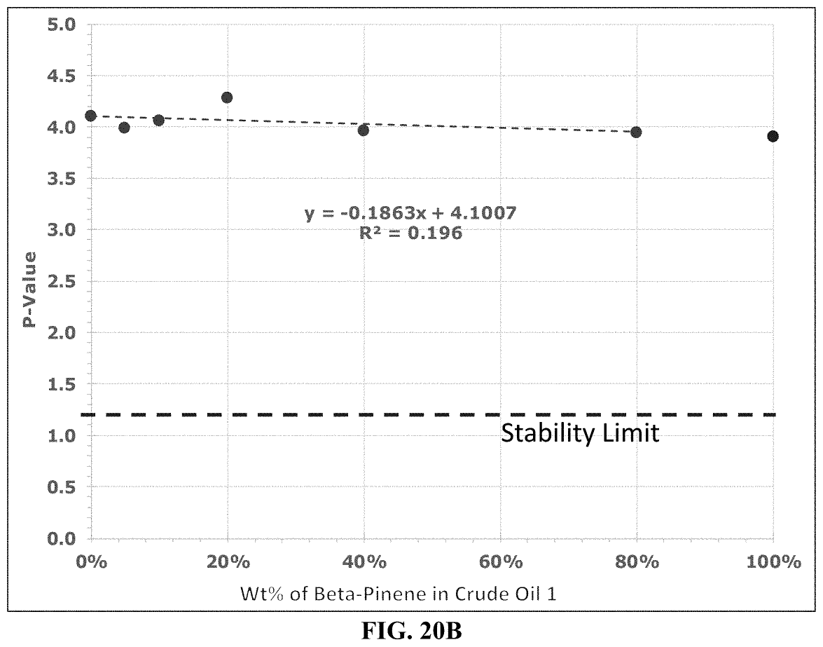

Furthermore, surprisingly, the degradable solvents d-limonene and beta-pinene generally kept asphaltenes stable in the Crude Oil 1 samples of FIGS. 20A-20B without any dedicated effort to keep the asphaltenes in solution in the Crude Oil 1 samples. Thus, in some embodiments, the upgraded hydrocarbon does not change its asphaltene stability by the addition of the degradable solvents (See FIGS. 20A-20B) as measured by ASTM D6703-19. Moreover, in some embodiments, the upgraded hydrocarbon has an asphaltene stability P-value of from at least 1.2 or more, for example, as each degradable solvent has an asphaltene stability P-value of from 1.2 or more as measured by ASTM D6703-19. This can greatly improve the economics of in situ upgrading processes.

DEGRADABLE SOLVENT: One or more degradable solvents may be injected into the injection well for in situ upgrading of a heavy hydrocarbon in a reservoir. The one or more degradable solvents may be injected without steam or with steam (e.g., injected with less conventional steam injection). Laws and regulations may vary from state to state and country to country, but practically any degradable solvent that can be injected into the reservoir according to the applicable laws and regulations may be utilized as described herein.

In one embodiment, each degradable solvent is degradable (e.g., thermally degradable, photodegradable, biodegradable, or any combination thereof) in of from 720 days or less under the reservoir conditions. For comparison, banana peels take up to two years (i.e., up to 712 days) to decompose when left out in the environment as explained in the following article: Shelley Hoose, “How Long Does It Take Banana Peels to Compost?”, Mar. 8, 2021.

In one embodiment, each degradable solvent is degradable in of from 720 days or less under the reservoir conditions (e.g., 700 days or less, 650 days or less, 600 days or less, 550 days or less, 500 days or less, 450 days or less, 400 days or less, 350 days or less, 300 days or less, 250 days or less, 200 days or less, 180 days or less, 150 days or less, 120 days or less, 110 days or less, 100 days or less, 95 days or less, 90 days or less, 85 days or less, 80 days or less, 75 days or less, 70 days or less, 65 days or less, 60 days or less, 55 days or less, 50 days or less, 45 days or less, 40 days or less, 35 days or less, or 30 days or less). For example, in one embodiment, each degradable solvent is degradable in of from 25 days to 720 days under the reservoir conditions, of from 25 days to 60 days under the reservoir conditions, of from 25 days to 120 days under the reservoir conditions, or of from 25 days to 180 days under the reservoir conditions.

For thermal degradation, in one embodiment, incubated at reservoir temperature in contact with reservoir water for 60 days, less than 25% (e.g., less than 20%, less than 15%, less than 10%, less than 5%, or less than 2.5%) of each degradable solvent remains as measured by gas chromatography. Turning to photodegradation, in one embodiment, eradiated with artificial sunlight at reservoir temperature in contact with reservoir water for 60 days, less than 25% (e.g., less than 20%, less than 15%, less than 10%, less than 5%, or less than 2.5%) of each degradable solvent remains as measured by gas chromatography. Turning to biodegradation, in one embodiment, less than 25% (e.g., less than 20%, less than 15%, less than 10%, less than 5%, or less than 2.5%) of each degradable solvent remains as measured by ASTM D6139-18 (at https://www.astm.org/Standards/D6139.htm), ASTM D5864-18 (at https://www.astm.org/Standards/D5864.htm), ASTM D6731-18 (at https://www.astm.org/Standards/D6731.htm), or any combination thereof at reservoir temperature in contact with reservoir water for 60 days. The term “reservoir water” refers to water or fluid from the reservoir. The reservoir water may be formation water, produced water, brine, etc. from the reservoir. In one embodiment, synthetic water that is substantially similar to water from the reservoir may even be utilized. The reservoir temperature refers to the temperature of the reservoir as previously discussed hereinabove. Degradation of terpenes is discussed further in the following: (i) Yu Yang, et al., Terpene Degradation and Extraction from Basil and Oregano Leaves Using Subcritical Water, Journal of Chromatography, 2007, 1152 (1-2): 262-7, (ii) Gerald W. McGraw et al., Thermal Degradation of Terpenes: Camphene, Δ³-Carene, Limonene, and α-Terpinene, Environmental Science & Technology, 1999, 33 (22), 4029-4033, (iii) X. Pan et al., Photodegradation of secondary organic aerosol generated from limonene oxidation by ozone studied with chemical ionization mass spectrometry, Atmospheric Chemistry and Physics Discussions, 9, 4727-4767, 2009, and/or (iv) Veronika Pospisilova et al., Photodegradation of α-Pinene Secondary Organic Aerosol Dominated by Moderately Oxidized Molecules, Environmental Science & Technology 2021, 55 (10), 6936-6943, each of which is incorporated by reference.

In one embodiment, each degradable solvent satisfies the following criteria: (a) an aromatic content of from less than 1% wt./wt. as measured by ASTM D6591-19. In one embodiment, each degradable solvent satisfies the following criteria: (b) an asphaltene stability P-value of from 1.2 or more as measured by ASTM D6703-19. In one embodiment, the flash point of each degradable solvent may be above 100° C. at 1 atmosphere. In another embodiment, the flash point of one or more of the degradable solvents may be below 100° C. at 1 atmosphere, such as when steam injection is not utilized.

In one embodiment, the one or more degradable solvents comprise a substituted cycloalkene. In one embodiment, the one or more degradable solvents comprise an unsaturated cyclohexyl ring. In one embodiment, the one or more degradable solvents comprise C₈-C₁₂ carbon atoms. In one embodiment, the one or more degradable solvents comprise a substituted cycloalkene, an unsaturated cyclohexyl ring, C₈-C₁₂ carbon atoms, or any combination thereof. In one embodiment, the one or more degradable solvents comprise one or more terpenes. In one embodiment, the one or more degradable solvents comprise one or more mineral oils. In one embodiment, the one or more degradable solvents comprise one or more esters. In one embodiment, the one or more degradable solvents comprise (i) one or more terpenes, (ii) one or more mineral oils, (iii) one or more esters, or any combination thereof (e.g., utilize at least one terpene and at least one mineral oil). In one embodiment, the one or more degradable solvents have a total viscosity of 10 centistokes (cSt) or less measured at 40° C. (e.g., total viscosity of 0.5 cSt to 10 cSt at 40° C.) (e.g., as measured by ASTM D445-19a).

In one embodiment, the one or more degradable solvents are injected into the reservoir at a ratio by volume of the one or more degradable solvents to the upgraded hydrocarbon produced of from at least 0.05:1 (e.g., at least 0.06:1, at least 0.07:1, at least 0.08:1, at least 0.09:1, at least 0.10:1, at least 0.11:1, at least 0.12:1, at least 0.13:1, or at least 0.14:1).

In one embodiment, the one or more degradable solvents are injected into the reservoir at a ratio by volume of the one or more degradable solvents to the upgraded hydrocarbon produced of from 0.15:1 or less (e.g., 0.14:1 or less, 0.13:1 or less, 0.12:1 or less, 0.11:1 or less, 0.10:1 or less, 0.09:1 or less, 0.08:1 or less, 0.07:1 or less, or 0.06:1 or less).

The one or more degradable solvents are injected into the reservoir at a ratio by volume of the one or more degradable solvents to the upgraded hydrocarbon produced of from any of the minimum values described above to any of the maximum values described above. For example, in one embodiment, the one or more degradable solvents are injected into the reservoir at a ratio by volume of the one or more degradable solvents to the upgraded hydrocarbon produced of from 0.05:1 to 0.15:1 (e.g., of from 0.05 vol/vol to 0.15 vol/vol), of from 0.05:1 to 0.10:1 (e.g., of from 0.05 vol/vol to 0.10 vol/vol), or of from 0.05:1 to 0.1:1 (e.g., of from 0.05 vol/vol to 0.1 vol/vol). The ratio of the one or more degradable solvent to upgraded hydrocarbon produced is expressed herein as volume/volume (v/v).

Terpene: In one embodiment, the one or more degradable solvents comprise one or more terpenes. In one embodiment, the one or more terpenes comprise a plant-derived terpene, a bio-derived terpene, or any combination thereof. A plant-derived terpene may be practically any terpene that is derived from a plant source, such as, but not limited to, a flower, a tree, or other plant or portion of a plant. A bio-derived terpene may be practically any terpene that is derived from a biological source, such as, but not limited to, a byproduct of animal milk (e.g., a byproduct of cow milk). In one embodiment, the one or more terpenes comprise d-limonene, beta-pinene, myrcene, terpinolene, alpha-farnesene, beta-caryophyllene, nerol, citral, camphor, menthol, geraniol, camphene, squalene, humulene, carvone, linalool, or any combination thereof. For example, the terpene may be a d-limonene (80% or more as measured by gas chromatography) with less than 5% alcohols and essentially no sugars.

In one embodiment, the one or more terpenes have a total viscosity of from at least 0.5 cSt at 40° C. (e.g., at least 1 cSt, at least 2 cSt, at least 3 cSt, at least 4 cSt, at least 5 cSt, at least 6 cSt, at least 7 cSt, at least 8 cSt, or at least 9 cSt).

In one embodiment, the one or more terpenes have a total viscosity of 10 cSt or less at 40° C. (e.g., 9 cSt or less, 8 cSt or less, 7 cSt or less, 6 cSt or less, 5 cSt or less, 4 cSt or less, 3 cSt or less, 2 cSt or less, or 1 cSt or less).

The total viscosity of the one or more terpenes may be any of the minimum values described above to any of the maximum values described above. For example, in one embodiment, the total viscosity of the one or more terpenes is of from 0.5 cSt to 10 cSt at 40° C., of from 0.5 cSt to 5 cSt at 40° C., or of from 3 cSt to 8 cSt at 40° C.

In one embodiment, a single degradable solvent such as d-limonene having a total viscosity of 0.5 cSt to 10 cSt at 40° C. may be injected at a ratio by volume of the one or more degradable solvents to upgraded hydrocarbon produced of from of from 0.05:1 to 0.15:1. In one embodiment, a single degradable solvent such as beta-pinene having a total viscosity of 0.5 cSt to 10 cSt at 40° C. may be injected at a ratio by volume of the one or more degradable solvents to upgraded hydrocarbon produced of from 0.05:1 to 0.15:1. Similarly, in one embodiment, a single degradable solvent, such as myrcene or terpinolene or one of the other terpenes, having a total viscosity of 0.5 cSt to 10 cSt at 40° C. may be injected at a ratio by volume of the one or more degradable solvents to upgraded hydrocarbon produced of from 0.05:1 to 0.15:1.

In one embodiment, two degradable solvents such as (i) d-limonene and (ii) beta-pinene may be injected into the reservoir. These two degradable solvents may have a total viscosity of 0.5 cSt to 10 cSt at 40° C. and they may be injected at a ratio by volume of the one or more degradable solvents to upgraded hydrocarbon produced of from 0.05:1 to 0.15:1.

In one embodiment, three degradable solvents such as (i) d-limonene, (ii) beta-pinene, and (iii) menthol may be injected into the reservoir. These three degradable solvents may have a total viscosity of 0.5 cSt to 10 cSt at 40° C. and they may be injected at a ratio by volume of the one or more degradable solvents to upgraded hydrocarbon produced of from 0.05:1 to 0.15:1.

Mineral Oil: In one embodiment, the one or more degradable solvents comprise one or more mineral oils. In one embodiment, one or more mineral oils containing a minimal concentration of aromatic components (e.g., aromatic content of from less than 1% wt./wt. as measured by ASTM D6591-19 may be utilized. In one embodiment, light mixtures of higher alkanes distillates from petroleum may be utilized. In one embodiment, mineral oils generated by (e.g., highly) hydrotreated petroleum distillates with aromatic content of from less than 1% wt./wt. as measured by ASTM D6591-19 may be used. In one embodiment, the one or more mineral oils comprise a paraffinic hydrocarbon (e.g., straight and branched-chain), a naphthenic hydrocarbon, or any combination thereof having carbon numbers of from 15 or more, boiling points in the range of from 300° C. to 600° C., and hydrotreated petroleum distillates with aromatic content of from less than 1% wt./wt. as measured by ASTM D6591-19.

In one embodiment, the one or more mineral oils have a total viscosity of from at least 0.5 cSt at 40° C. (e.g., at least 1 cSt, at least 2 cSt, at least 3 cSt, at least 4 cSt, at least 5 cSt, at least 6 cSt, at least 7 cSt, at least 8 cSt, or at least 9 cSt).

In one embodiment, the one or more mineral oils have a total viscosity of 10 cSt or less at 40° C. (e.g., 9 cSt or less, 8 cSt or less, 7 cSt or less, 6 cSt or less, 5 cSt or less, 4 cSt or less, 3 cSt or less, 2 cSt or less, or 1 cSt or less).

The total viscosity of the one or more mineral oils may be any of the minimum values described above to any of the maximum values described above. For example, in one embodiment, the total viscosity of the one or more mineral oils is of from 0.5 cSt to 10 cSt at 40° C., of from 0.5 cSt to 5 cSt at 40° C., or of from 3 cSt to 8 cSt at 40° C.

In one embodiment, a single mineral oil comprising a paraffinic hydrocarbon having a total viscosity of 0.5 cSt to 10 cSt at 40° C. may be injected at a ratio by volume of the one or more degradable solvents to upgraded hydrocarbon produced of from of from 0.05:1 to 0.15:1. In one embodiment, a single mineral oil comprising a naphthenic hydrocarbon having a total viscosity of 0.5 cSt to 10 cSt at 40° C. may be injected at a ratio by volume of the one or more degradable solvents to upgraded hydrocarbon produced of from 0.05:1 to 0.15:1.

In one embodiment, two degradable solvents such as (i) a mineral oil comprising a paraffinic hydrocarbon and (ii) a mineral oil comprising a naphthenic hydrocarbon may be injected into the reservoir. These two degradable solvents may have a total viscosity of 0.5 cSt to 10 cSt at 40° C. and they may be injected at a ratio by volume of the one or more degradable solvents to upgraded hydrocarbon produced of from 0.05:1 to 0.15:1.

Ester: In one embodiment, the one or more degradable solvents comprise one or more esters. In one embodiment, the one or more esters comprise a bio-derived ester. The bio-derived ester may be practically any ester that is derived from a biological source, such as, but not limited to, a byproduct of the hydrolysis of fatty acids and lipids. The bio-derived ester may be methyl stearate. The bio-derived ester may be ethyl stearate. The bio-derived ester may be methyl oleate. The bio-derived ester may be ethyl oleate. The bio-derived ester may be methyl palmitate. The bio-derived ester may be ethyl palmitate. The bio-derived ester may be methyl linoleate. The bio-derived ester may be ethyl linoleate. In one embodiment, the one or more esters comprise ethyl lactate, ethyl acetate, methyl acetate, methyl stearate, ethyl stearate, methyl oleate, ethyl oleate, methyl palmitate, ethyl palmitate, methyl linoleate, ethyl linoleate, or any combination thereof. In one embodiment, a combination of at least one bio-derived ester and at least one non-bio-derived ester may even be utilized.

In one embodiment, the one or more esters have a total viscosity of from at least 0.5 cSt at 40° C. (e.g., at least 1 cSt, at least 2 cSt, at least 3 cSt, at least 4 cSt, at least 5 cSt, at least 6 cSt, at least 7 cSt, at least 8 cSt, or at least 9 cSt).

In one embodiment, the one or more esters have a total viscosity of 10 cSt or less at 40° C. (e.g., 9 cSt or less, 8 cSt or less, 7 cSt or less, 6 cSt or less, 5 cSt or less, 4 cSt or less, 3 cSt or less, 2 cSt or less, or 1 cSt or less).

The total viscosity of the one or more esters may be any of the minimum values described above to any of the maximum values described above. For example, in one embodiment, the total viscosity of the one or more esters is of from 0.5 cSt to 10 cSt at 40° C., of from 0.5 cSt to 5 cSt at 40° C., or of from 3 cSt to 8 cSt at 40° C.

In one embodiment, a single ester such as methyl acetate having a total viscosity of 0.5 cSt to 10 cSt at 40° C. may be injected at a ratio by volume of the one or more degradable solvents to upgraded hydrocarbon produced of from of from 0.05:1 to 0.15:1. In one embodiment, a single ester such as methyl linoleate or other ester listed herein having a total viscosity of 0.5 cSt to 10 cSt at 40° C. may be injected at a ratio by volume of the one or more degradable solvents to upgraded hydrocarbon produced of from 0.05:1 to 0.15:1.

In one embodiment, two degradable solvents such as (i) methyl stearate and (2) ethyl oleate may be injected into the reservoir. These two degradable solvents may have a total viscosity of 0.5 cSt to 10 cSt at 40° C. and they may be injected at a ratio by volume of the one or more degradable solvents to upgraded hydrocarbon produced of from 0.05:1 to 0.15:1.

Degradable Solvent Selection: In one aspect, the disclosure can generally relate to a method for selecting a degradable solvent for use in a process for in situ upgrading of a heavy hydrocarbon in a reservoir. The method may be repeated to select multiple degradable solvents. However, those of ordinary skill in the art will appreciate that the selection method may or may not be utilized depending on the embodiment.

The selection method includes selecting the degradable solvent for injection into the reservoir, and the selected degradable solvent satisfies the following criteria: (a) an aromatic content of from less than 1% wt./wt. as measured by ASTM D6591-19, and (b) an asphaltene stability P-value of from 1.2 or more as measured by ASTM D6703-19. The criteria related to asphaltene stability may reduce or prevent asphaltene precipitation by the asphaltenes in the heavy hydrocarbon as discussed in connection with FIGS. 20A-20B.

Turning to (a), in one embodiment, the selected degradable solvent has an aromatic content as measured by ASTM D6591-19 of from less than 1% wt./wt. (e.g., less than 0.9% wt./wt., less than 0.8% wt./wt., less than 0.7% wt./wt., less than 0.6% wt./wt., less than 0.5% wt./wt., less than 0.4% wt./wt., less than 0.3% wt./wt., less than 0.2% wt./wt., or less than 0.1% wt./wt.).

Turning to (b), the temperature for ASTM D6703-19 is 25° C. In one embodiment, the selected degradable solvent has the asphaltene stability P-value as measured by ASTM D6703-19 of from at least 1.2 (e.g., at least 1.3, at least 1.4, at least 1.5, at least 1.6, at least 1.7, at least 1.8, at least 1.9, at least 2, at least 3, at least 4, at least 5, at least 6, at least 7, at least 8, or at least 9).

In one embodiment, the selected degradable solvent has the asphaltene stability P-value as measured by ASTM D6703-19 of from 10 or less (e.g., 9 or less, 8 or less, 7 or less, 6 or less, 5 or less, 4 or less, 3 or less, 2 or less, 1.9 or less, 1.8 or less, 1.7 or less, 1.6 or less, 1.5 or less, 1.4 or less, or 1.3 or less).

The selected degradable solvent has the asphaltene stability P-value as measured by ASTM D6703-19 from any of the minimum values described above to any of the maximum values described above. For example, in one embodiment, the selected degradable solvent has the asphaltene stability P-value as measured by ASTM D6703-19 of from 1.2 to 10, of from 1.2 to 5, or of from 1.2 to 4.5.

Table 1 below provides various examples of degradable solvents that may be utilized, where Po=Maltene peptizing power and P=State of peptization. As can be seen, the P-values of the degradable solvents in Table 1 are higher than 1.2 and the aromatic contents are lower than 1% wt./wt. A person of ordinary skill in the art will appreciate that the list of degradable solvents in Table 1 is not exhaustive and other degradable solvents may be utilized.

TABLE 1

| | | | ASTM D6591-19 |
|---|---|---|---|
| | ASTM D6703-19 | | Total Aromatics |
| Name | Po | P | Content |
| d-Limonene (concentration of | 0.91 | 3.55 | Less than |
| approximately 94% by GCxGC) | | | 1% wt./wt. |
| d-Limonene (concentration of | 0.90 | 3.52 | Less than |
| approximately 88% by GCxGC) | | | 1% wt./wt. |
| Terpenes Blend (concentration of | 1.10 | 4.31 | Less than |
| approximately 37% by GCxGC) | | | 1% wt./wt. |
| d-Limonene (concentration of | 0.92 | 3.62 | Less than |
| approximately 99% by GCxGC) | | | 1% wt./wt. |
| Beta-Pinene (concentration of | 1.00 | 3.91 | Less than |
| approximately 99%) | | | 1% wt./wt. |
| Ethyl Acetate (concentration of | 0.93 | 3.62 | Less than |
| approximately 99%) | | | 1% wt./wt. |

Non-Condensable Gas: One or more non-condensable gases may be injected to reduce or prevent loss of the one or more degradable solvents. In one embodiment, one or more non-condensable gases may be co-injected with the one or more degradable solvents. The one or more non-condensable gases may comprise carbon dioxide, methane, or any combination thereof. Practically any source of methane and/or carbon dioxide may be utilized for the co-injection. For example, sequestered or captured or stored carbon dioxide may be utilized for the co-injection. For example, sequestered or captured or stored methane may be utilized for the co-injection.

The total amount of the one or more non-condensable gases that may be injected is of from at least 4 wt % (e.g., at least 5 wt %, at least 10 wt %, at least 15 wt %, at least 20 wt %, at least 25 wt %, at least 30 wt %, or at least 33 wt %).

In one embodiment, the total amount of the one or more non-condensable gases that may be injected is of from 34 wt % or less (e.g., 30 wt % or less, 25 wt % or less, 20 wt % or less, 15 wt % or less, 10 wt % or less, or 5 wt % or less).

The total amount of the one or more non-condensable gases that may be injected is from any of the minimum values described above to any of the maximum values described above. For example, in one embodiment, the total amount of the one or more non-condensable gases that may be injected is of from 4 wt % to 34 wt %, of from 15 wt % to 34 wt %, or of from 4 wt % to 20 wt %.

ADDITIVE: One or more additives may be injected in some embodiments. For example, one or more detergents may be injected in some embodiments. One or more demulsifiers may be injected in some embodiments. One or more scavengers may be injected in some embodiments. One or more biocides may be injected in some embodiments. A combination of any of these additives may be injected in some embodiments, for example, a particular embodiment may include injection of one or more detergents, one or more demulsifiers, one or more scavengers, and one or more biocides. The one or more additives may be tailored to (i) the one or more degradable solvents to be injected, (ii) a non-condensable gas to be injected (if any), (iii) steam to be injected (if any), (iv) the reservoir, (v) the heavy hydrocarbon, (vi) the well(s), (vii) hydrocarbon recovery method such as cyclic solvent stimulation (CSvS) or solvent flooding, etc. An additive package, for example, that includes multiple additives may be utilized in some embodiments.

The purpose and concentration of each of these additives is discussed hereinbelow. For example, the small concentration of the one or more additives allows the viscosity of the one or more degradable solvents to not increase significantly. The ratios of the one or more additives to the one or more degradable solvents provided hereinbelow may be injected per slug in a CSvS implementation or per flood in a solvent flooding implementation.

In one embodiment, the one or more additives are injected into the reservoir at a ratio by weight of the one or more additives to the one or more degradable solvents of from at least 10 ppm:1 (e.g., at least 20 ppm:1, at least 30 ppm:1, at least 40 ppm:1, at least 50 ppm:1, at least 60 ppm:1, at least 70 ppm:1, at least 80 ppm:1, at least 90 ppm:1, at least 100 ppm:1, at least 125 ppm:1, at least 150 ppm:1, at least 175 ppm:1, at least 200 ppm:1, at least 225 ppm:1, at least 250 ppm:1, at least 275 ppm:1, at least 300 ppm:1, at least 325 ppm:1, at least 350 ppm:1, at least 375 ppm:1, at least 400 ppm:1, at least 425 ppm:1, at least 450 ppm:1, or at least 475 ppm:1, at least 500 ppm:1, at least 550 ppm:1, at least 600 ppm:1, at least 650 ppm:1, at least 700 ppm:1, at least 750 ppm:1, at least 800 ppm:1, at least 850 ppm:1, at least 900 ppm:1, at least 950 ppm:1, at least 1000 ppm:1, at least 1500 ppm:1, at least 2000 ppm:1, at least 2500 ppm:1, at least 3000 ppm:1, at least 3500 ppm:1, at least 4000 ppm:1, at least 4500 ppm:1, at least 5000 ppm:1, at least 5500 ppm:1, or at least 6000 ppm:1). For the purposes of this disclosure, the ratio is measured as weight/weight, i.e., milligrams of additive(s)/kilograms of degradable solvent(s) in the laboratory. In the field, the ratio may be expressed as kilogram of additive(s)/1000 Ton (1000 kilograms) of degradable solvent(s).

In one embodiment, the one or more additives are injected into the reservoir at a ratio by weight of the one or more additives to the one or more degradable solvents of from 6500 ppm:1 or less (e.g., 6000 ppm:1 or less, 5500 ppm:1 or less, 5000 ppm:1 or less, 4500 ppm:1 or less, 4000 ppm:1 or less, 3500 ppm:1 or less, 3000 ppm:1 or less, 2500 ppm:1 or less, 2000 ppm:1 or less, 1500 ppm:1 or less, 1000 ppm:1 or less, 950 ppm:1 or less, 900 ppm:1 or less, 850 ppm:1 or less, 800 ppm:1 or less, 750 ppm:1 or less, 700 ppm:1 or less, 650 ppm:1 or less, 600 ppm:1 or less, 550 ppm:1 or less, 500 ppm:1 or less, 475 ppm:1 or less, 450 ppm:1 or less, 425 ppm:1 or less, 400 ppm:1 or less, 375 ppm:1 or less, 350 ppm:1 or less, 325 ppm:1 or less, 300 ppm:1 or less, 275 ppm:1 or less, 250 ppm:1 or less, 225 ppm:1 or less, 200 ppm:1 or less, 175 ppm:1 or less, 150 ppm:1 or less, 125 ppm:1 or less, 100 ppm:1 or less, 90 ppm:1 or less, 80 ppm:1 or less, 70 ppm:1 or less, 60 ppm:1 or less, 50 ppm:1 or less, 40 ppm:1 or less, 30 ppm:1 or less, or 20 ppm:1 or less).

The one or more additives are injected into the reservoir at a ratio by weight of the one or more additives to the one or more degradable solvents of from any of the minimum values described above to any of the maximum values described above. For example, in some embodiments, the one or more additives are injected into the reservoir at a ratio by weight of the one or more additives to the one or more degradable solvents of from 10 ppm:1 to 6500 ppm:1, of from 10 ppm:1 to 2000 ppm:1, of from 10 ppm:1 to 1000 ppm:1, or of from 40 ppm:1 to 2000 ppm:1.

DETERGENT: One or more detergents may be injected to reduce or prevent obstructions in the reservoir from debris, dust particles, etc. The one or more detergents may be used to control the debris and dust particles during the downhole injection of the one or more degradable solvents. In one embodiment, the one or more detergents comprise an alkyl benzene sulfonate (e.g., Na, Ca, Mg, or any combination thereof), an alkyl naphthalene sulfonate (e.g., Na, NH₄, Zn, Pb, Ca, Ba, or any combination thereof), a sulfurized alkylphenol metal salt (e.g., Ca, Ba, Mg, or any combination thereof), or any combination thereof. In all of these cases, alkyl may be hexly, octyl, nonyl, decyl, dodecyl, or hexadecyl derivatives. The total amount of the one or more detergents that may be injected per slug in a CSvS implementation or per flood in a solvent flooding implementation is provided hereinbelow.

In one embodiment, the total amount of the one or more detergents that may be injected is of from at least 10 ppm (e.g., at least 20 ppm, at least 30 ppm, at least 40 ppm, at least 50 ppm, at least 60 ppm, at least 70 ppm, at least 80 ppm, at least 90 ppm, at least 100 ppm, at least 125 ppm, at least 150 ppm, at least 175 ppm, at least 200 ppm, at least 225 ppm, at least 250 ppm, at least 275 ppm, at least 300 ppm, at least 325 ppm, at least 350 ppm, at least 375 ppm, at least 400 ppm, at least 425 ppm, at least 450 ppm, at least 475 ppm, at least 500 ppm, at least 550 ppm, at least 600 ppm, at least 650 ppm, at least 700 ppm, at least 750 ppm, at least 800 ppm, at least 850 ppm, at least 900 ppm, at least 950 ppm, at least 1000 ppm, at least 1500 ppm, at least 2000 ppm, at least 2500 ppm, at least 3000 ppm, at least 3500 ppm, at least 4,000 ppm, or at least 4500 ppm).

In one embodiment, the total amount of the one or more detergents that may be injected is of from 5000 ppm or less (e.g., 4500 ppm or less, 4000 ppm or less, 3500 ppm or less, 3000 ppm or less, 2500 ppm or less, 2000 ppm or less, 1500 ppm or less, 1000 ppm or less, 950 ppm or less, 900 ppm or less, 850 ppm or less, 800 ppm or less, 750 ppm or less, 700 ppm or less, 650 ppm or less, 600 ppm or less, 550 ppm or less, 500 ppm or less, 475 ppm or less, 450 ppm or less, 425 ppm or less, 400 ppm or less, 375 ppm or less, 350 ppm or less, 325 ppm or less, 300 ppm or less, 275 ppm or less, 250 ppm or less, 225 ppm or less, 200 ppm or less, 175 ppm or less, 150 ppm or less, 125 ppm or less, 100 ppm or less, 90 ppm or less, 80 ppm or less, 70 ppm or less, 60 ppm or less, 50 ppm or less, 40 ppm or less, 30 ppm or less, or 20 ppm or less).

The total amount of the one or more detergents that may be injected is from any of the minimum values described above to any of the maximum values described above. For example, in one embodiment, the total amount of the one or more detergents that may be injected is of from 10 ppm to 5000 ppm, of from 10 ppm to 1000 ppm, of from 10 ppm to 2500 ppm, of from 50 ppm to 200 ppm, or of from 100 ppm to 2500 ppm.

In one embodiment, a single detergent such as an alkyl benzene sulfonate may be injected in a total amount of from 10 ppm to 5000 ppm. In one embodiment, a single detergent such as an alkyl naphthalene sulfonate may be injected in a total amount of from 10 ppm to 5000 ppm. In one embodiment, a single detergent such as a sulfurized alkylphenol metal salt may be injected in a total amount of from 10 ppm to 5000 ppm.

In one embodiment, two detergents such as (i) an alkyl benzene sulfonate and (ii) an alkyl naphthalene sulfonate may be injected in a total amount of from 10 ppm to 5000 ppm. For example, 5 ppm to 2500 ppm of an alkyl benzene sulfonate and 5 ppm to 2500 ppm of an alkyl naphthalene sulfonate may be injected.

In one embodiment, two detergents such as (i) an alkyl benzene sulfonate and (ii) a sulfurized alkylphenol metal salt may be injected in a total amount of from 10 ppm to 5000 ppm. For example, 5 ppm to 2500 ppm of an alkyl benzene sulfonate and 5 ppm to 2500 ppm of a sulfurized alkylphenol metal salt may be injected.

In one embodiment, two detergents such as (i) an alkyl naphthalene sulfonate and (ii) a sulfurized alkylphenol metal salt may be injected in a total amount of from 10 ppm to 5000 ppm. For example, 5 ppm to 2500 ppm of an alkyl naphthalene sulfonate and 5 ppm to 2500 ppm of a sulfurized alkylphenol metal salt may be injected.

In one embodiment, three detergents such as (i) an alkyl benzene sulfonate, (ii) alkyl naphthalene sulfonate, and (iii) a sulfurized alkylphenol metal salt may be injected in a total amount of from 10 ppm to 5000 ppm. For example, 4 ppm to 3000 ppm of an alkyl benzene sulfonate, 3 ppm to 2000 ppm of an alkyl naphthalene sulfonate, and 3 ppm to 2000 ppm of a sulfurized alkylphenol metal salt may be injected.

DEMULSIFIER: One or more demulsifiers may be injected to reduce or prevent emulsion formation from brine, water, sand, etc. The one or more demulsifiers may be employed to control and mitigate emulsion formation from brine, water, and sand during enhanced oil recovery of heavy hydrocarbon. In one embodiment, the one or more demulsifiers comprise a polyalkoxylate block copolymer, a polyalkoxylate block ester derivative, an alkylphenol-aldehyde resin with alkoxylate, an alkylphenol-aldehyde resin without alkoxylate, a polyalkoxylate of polyol, a glycidyl ether, or any combination thereof. In all of these cases, alkyl may be hexly, octyl, nonyl, decyl, dodecyl, or hexadecyl derivatives. The total amount of the one or more demulsifiers that may be injected per slug in a CSvS implementation or per flood in a solvent flooding implementation is provided hereinbelow.

In one embodiment, the total amount of the one or more demulsifiers that may be injected is of from at least 10 ppm (e.g., at least 20 ppm, at least 30 ppm, at least 40 ppm, at least 50 ppm, at least 60 ppm, at least 70 ppm, at least 80 ppm, at least 90 ppm, at least 100 ppm, at least 125 ppm, at least 150 ppm, at least 175 ppm, at least 200 ppm, at least 225 ppm, at least 250 ppm, at least 275 ppm, at least 300 ppm, at least 325 ppm, at least 350 ppm, at least 375 ppm, at least 400 ppm, at least 425 ppm, at least 450 ppm, or at least 475 ppm).

In one embodiment, the total amount of the one or more demulsifiers that may be injected is of from 500 ppm or less (e.g., 475 ppm or less, 450 ppm or less, 425 ppm or less, 400 ppm or less, 375 ppm or less, 350 ppm or less, 325 ppm or less, 300 ppm or less, 275 ppm or less, 250 ppm or less, 225 ppm or less, 200 ppm or less, 175 ppm or less, 150 ppm or less, 125 ppm or less, 100 ppm or less, 90 ppm or less, 80 ppm or less, 70 ppm or less, 60 ppm or less, 50 ppm or less, 40 ppm or less, 30 ppm or less, or 20 ppm or less).

The total amount of the one or more demulsifiers that may be injected is from any of the minimum values described above to any of the maximum values described above. For example, in one embodiment, the total amount of the one or more detergents that may be injected is of from 10 ppm to 500 ppm, of from 20 ppm to 400 ppm, or of from 30 ppm to 300 ppm.

In one embodiment, a single demulsifier such as a polyalkoxylate block copolymer may be injected in a total amount of from 10 ppm to 500 ppm. In one embodiment, a single demulsifier such as a polyalkoxylate block ester derivative may be injected in a total amount of from 10 ppm to 500 ppm. In one embodiment, a single demulsifier such as an alkylphenol-aldehyde resin with alkoxylate may be injected in a total amount of from 10 ppm to 500 ppm. In one embodiment, a single demulsifier such as an alkylphenol-aldehyde resin without alkoxylate may be injected in a total amount of from 10 ppm to 500 ppm. In one embodiment, a single demulsifier such as a polyalkoxylate of polyol may be injected in a total amount of from 10 ppm to 500 ppm. In one embodiment, a single demulsifier such as a glycidyl ether may be injected in a total amount of from 10 ppm to 500 ppm.

In one embodiment, two demulsifiers such as (i) a polyalkoxylate block copolymer and (ii) a polyalkoxylate block ester derivative may be injected in a total amount of from 10 ppm to 500 ppm. For example, 5 ppm to 250 ppm of a polyalkoxylate block copolymer and 5 ppm to 250 ppm of a polyalkoxylate block ester derivative may be injected.

In one embodiment, two demulsifiers such as (i) a polyalkoxylate of polyol and (ii) a glycidyl ether may be injected in a total amount of from 10 ppm to 500 ppm. For example, 5 ppm to 250 ppm of a polyalkoxylate of polyol and 5 ppm to 250 ppm of a glycidyl ether may be injected.

In one embodiment, three demulsifiers such as (i) a polyalkoxylate block copolymer, (ii) a polyalkoxylate block ester derivative, and (iii) an alkylphenol-aldehyde resin with alkoxylate may be injected in a total amount of from 10 ppm to 500 ppm. For example, 3 ppm to 300 ppm of a polyalkoxylate block copolymer, 2 ppm to 200 ppm of a polyalkoxylate block ester derivative, and 2 ppm to 200 ppm of an alkylphenol-aldehyde resin with alkoxylate may be injected.

In one embodiment, four demulsifiers such as (i) a polyalkoxylate block copolymer, (ii) a polyalkoxylate block ester derivative, (iii) an alkylphenol-aldehyde resin with alkoxylate, and (iv) a polyalkoxylate of polyol may be injected in a total amount of from 10 ppm to 500 ppm. For example, 2.5 ppm to 150 ppm of a polyalkoxylate block copolymer, 2.5 ppm to 100 ppm of a polyalkoxylate block ester derivative, 2.5 ppm to 100 ppm of an alkylphenol-aldehyde resin with alkoxylate, and 2.5 ppm to 100 ppm of a polyalkoxylate of polyol may be injected.

In one embodiment, five demulsifiers such as (i) a polyalkoxylate block copolymer, (ii) a polyalkoxylate block ester derivative, (iii) an octylphenol-aldehyde resin with alkoxylate, (iv) a glycidyl ether, and (v) a nonylphenol-aldehyde resin may be injected in a total amount of from 10 ppm to 500 ppm. For example, 2 ppm to 100 ppm of a polyalkoxylate block copolymer, 2 ppm to 100 ppm of a polyalkoxylate block ester derivative, 2 ppm to 100 ppm of an octylphenol-aldehyde resin with alkoxylate, 2 ppm to 100 ppm of a glycidyl ether, and from 2 ppm to 100 ppm of a nonylphenol-aldehyde resin may be injected.

SCAVENGER: One or more scavengers (e.g., oxygen scavenger, radical scavenger, or any combination thereof) may be injected to reduce the rate of decomposition of the one or more degradable solvents by oxidation. In one embodiment, the one or more scavengers comprise an aromatic amine (e.g., pyridine, aniline, etc.), an alkyl sulfide (e.g., an alkyl sulfide with a general formula R—Sₓ—R—S—R in which R=hexyl, octyl, nonyl, decyl, dodecyl, or hexadecyl), a hindered phenol (e.g., 2, 6-tert-butyl, alkyl phenol in which alkyl=hexyl, octyl, nonyl, decyl, dodecyl, or hexadecyl derivatives), or any combination thereof. In all of these cases, alkyl may be hexly, octyl, nonyl, decyl, dodecyl, or hexadecyl derivatives. The total amount of the one or more scavengers that may be injected per slug in a CSvS implementation or per flood in a solvent flooding implementation is provided hereinbelow.

In one embodiment, the total amount of the one or more scavengers that may be injected is of from at least 10 ppm (e.g., at least 20 ppm, at least 30 ppm, at least 40 ppm, at least 50 ppm, at least 60 ppm, at least 70 ppm, at least 80 ppm, at least 90 ppm, at least 100 ppm, at least 125 ppm, at least 150 ppm, at least 175 ppm, at least 200 ppm, at least 225 ppm, at least 250 ppm, at least 275 ppm, at least 300 ppm, at least 325 ppm, at least 350 ppm, at least 375 ppm, at least 400 ppm, at least 425 ppm, at least 450 ppm, or at least 475 ppm).

In one embodiment, the total amount of the one or more scavengers that may be injected of from 500 ppm or less (e.g., 475 ppm or less, 450 ppm or less, 425 ppm or less, 400 ppm or less, 375 ppm or less, 350 ppm or less, 325 ppm or less, 300 ppm or less, 275 ppm or less, 250 ppm or less, 225 ppm or less, 200 ppm or less, 175 ppm or less, 150 ppm or less, 125 ppm or less, 100 ppm or less, 90 ppm or less, 80 ppm or less, 70 ppm or less, 60 ppm or less, 50 ppm or less, 40 ppm or less, 30 ppm or less, or 20 ppm or less).

The total amount of the one or more scavengers that may be injected is from any of the minimum values described above to any of the maximum values described above. For example, in one embodiment, the total amount of the one or more scavengers that may be injected is of from 10 ppm to 500 ppm, of from 20 ppm to 400 ppm, or of from 30 ppm to 300 ppm.

In one embodiment, a single scavenger such as an aromatic amine may be injected in a total amount of from 10 ppm to 500 ppm. In one embodiment, a single scavenger such as an alkyl sulfide may be injected in a total amount of from 10 ppm to 500 ppm. In one embodiment, a single scavenger such as a hindered phenol may be injected in a total amount of from 10 ppm to 500 ppm.

In one embodiment, two scavengers such as (i) an aromatic amine and (ii) an alkyl sulfide may be injected in a total amount of from 10 ppm to 500 ppm. For example, 5 ppm to 250 ppm of an aromatic amine and 5 ppm to 250 ppm of an alkyl sulfide may be injected.

In one embodiment, two scavengers such as (i) an aromatic amine and (ii) a hindered phenol may be injected in a total amount of from 10 ppm to 500 ppm. For example, 5 ppm to 250 ppm of an aromatic amine and 5 ppm to 250 ppm of a hindered phenol may be injected.

In one embodiment, two scavengers such as (i) an alkyl sulfide and (ii) a hindered phenol may be injected in a total amount of from 10 ppm to 500 ppm. For example, 5 ppm to 250 ppm of an alkyl sulfide and 5 ppm to 250 ppm of a hindered phenol may be injected.

In one embodiment, three scavengers such as (i) an aromatic amine, (ii) an alkyl sulfide, and (iii) a hindered phenol may be injected in a total amount of from 10 ppm to 500 ppm. For example, 3 ppm to 150 ppm of an aromatic amine, 3 ppm to 150 ppm of an alkyl sulfide, and 4 ppm to 200 ppm of a hindered phenol may be injected.

BIOCIDE: One or more biocides may be injected to reduce the rate of degradation of the one or more degradable solvents by sulfate-reducing bacteria, slime-forming bacteria, iron-oxidizing bacteria, etc. In one embodiment, the one or more biocides comprise an aldehyde (e.g., formaldehyde, glutaraldehyde, ortho-phthalic aldehyde, glycolaldehyde, acrolein ortho-phthalic aldehyde or any combination thereof), a quaternary ammonium salt, an amine, a diamine, an isothiazolone, a phosphonium sulfate (e.g., tetrakis (hydroxymethyl) phosphonium sulfate), or any combination thereof. The biocide may also be referred to as a bactericide. The total amount of the one or more biocides that may be injected per slug in a CSvS implementation or per flood in a solvent flooding implementation is provided hereinbelow.

In one embodiment, the total amount of the one or more biocides that may be injected is of from at least 10 ppm (e.g., at least 20 ppm, at least 30 ppm, at least 40 ppm, at least 50 ppm, at least 60 ppm, at least 70 ppm, at least 80 ppm, at least 90 ppm, at least 100 ppm, at least 125 ppm, at least 150 ppm, at least 175 ppm, at least 200 ppm, at least 225 ppm, at least 250 ppm, at least 275 ppm, at least 300 ppm, at least 325 ppm, at least 350 ppm, at least 375 ppm, at least 400 ppm, at least 425 ppm, at least 450 ppm, or at least 475 ppm).

In one embodiment, the total amount of the one or more biocides that may be injected is of from 500 ppm or less (e.g., 475 ppm or less, 450 ppm or less, 425 ppm or less, 400 ppm or less, 375 ppm or less, 350 ppm or less, 325 ppm or less, 300 ppm or less, 275 ppm or less, 250 ppm or less, 225 ppm or less, 200 ppm or less, 175 ppm or less, 150 ppm or less, 125 ppm or less, 100 ppm or less, 90 ppm or less, 80 ppm or less, 70 ppm or less, 60 ppm or less, 50 ppm or less, 40 ppm or less, 30 ppm or less, or 20 ppm or less).

The total amount of the one or more biocides that may be injected is from any of the minimum values described above to any of the maximum values described above. For example, in one embodiment, the total amount of the one or more biocides that may be injected is of from 10 ppm to 500 ppm, of from 20 ppm to 400 ppm, or of from 30 ppm to 300 ppm.

In one embodiment, a single biocide such as an aldehyde may be injected in a total amount of from 10 ppm to 500 ppm. In one embodiment, a single biocide such as a quaternary ammonium salt may be injected in a total amount of from 10 ppm to 500 ppm. In one embodiment, a single biocide such as a phosphonium sulfate or any of the other biocides listed herein may be injected in a total amount of from 10 ppm to 500 ppm.

In one embodiment, two biocides such as (i) an aldehyde and (ii) a quaternary ammonium salt may be injected in a total amount of from 10 ppm to 500 ppm. For example, 5 ppm to 250 ppm of an aldehyde and 5 ppm to 250 ppm of a quaternary ammonium salt may be injected.

In one embodiment, two biocides such as (i) an aldehyde and (ii) a phosphonium sulfate may be injected in a total amount of from 10 ppm to 500 ppm. For example, 5 ppm to 250 ppm of an aldehyde and 5 ppm to 250 ppm of a phosphonium sulfate may be injected.

In one embodiment, two biocides such as (i) a quaternary ammonium salt and (ii) a phosphonium sulfate may be injected in a total amount of from 10 ppm to 500 ppm. For example, 5 ppm to 250 ppm of a quaternary ammonium salt and 5 ppm to 250 ppm of a phosphonium sulfate may be injected.

In one embodiment, three biocides such as (i) an aldehyde, (ii) a quaternary ammonium salt, and (iii) a phosphonium sulfate may be injected in a total amount of from 10 ppm to 500 ppm. For example, 4 ppm to 200 ppm of an aldehyde, 3 ppm to 100 ppm of a quaternary ammonium salt, and 3 ppm to 100 ppm of a phosphonium sulfate may be injected.

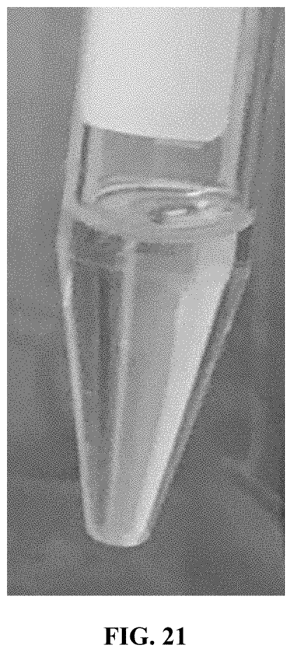

INJECTION: One or more degradable solvents and one or more additives are injected for in situ upgrading of a heavy hydrocarbon in a reservoir. During our investigation, it has been discovered that the use of degradable solvents alone may lead to formation damage due to the presence of dust and debris, increase oil viscosity via downhole formation of water-in-oil emulsions, and premature decomposition of the degradable solvents via dissolved oxygen and bacteria (see FIG. 21). For these reasons, this disclosure relates to injection of one or more degradable solvents (e.g., >99 wt. %) and one or more additives (e.g., <1 wt %). The one or more degradable solvents may have a total viscosity of 10 centistokes or less measured at 40° C. The one or more additives may be used in small concentrations to avoid significantly increasing the viscosity of the one or more degradable solvents. As an example, the ratio between the one or more degradable solvents injected and the hydrocarbon produced may be of from 0.05:1 to 0.15 (e.g., 0.05 vol/vol and 0.15 vol/vol) such that up to 20 bbl of upgraded hydrocarbon may be produced (SvOR=5 vol %) for every barrel of degradable solvent(s) injected. The injection may be accomplished at reservoir temperature or by using warmed degradable solvent formulations (e.g., T<200° C.) without the use of steam. The volume and type of the degradable solvent(s) and the additive(s) to inject may depend on compatibility of the degradable solvent(s) and the additive(s), reservoir conditions, volume of upgraded hydrocarbon to be produced, etc.

The one or more degradable solvents and the one or more additives may be injected into the injection well together (e.g., co-injected) or injected into the injection well in practically any order. The one or more degradable solvents and the one or more additives may be injected into the injection well without steam. The one or more degradable solvents and the one or more additives form a blend in the reservoir that comprises an upgraded hydrocarbon that has an API gravity greater than an initial API gravity of the heavy hydrocarbon and a viscosity lower than an initial viscosity of the heavy hydrocarbon. Moreover, the one or more additives may protect the one or more degradable solvents and allow them to travel at least 10 meters, even at least 30 meters, and even at least 70 meters from the injection well, thus enhancing production. In one embodiment, the injection into the injection well of the one or more degradable solvents and/or the one or more additives may be at a pressure sufficiently high to create fractures and/or dilate the reservoir 14, thereby increasing penetration into the reservoir 14 at vapor conditions (e.g., reservoir conditions including reservoir temperature and reservoir pressure), yet sufficiently low to prevent breaching a caprock over the reservoir 14. Other advantageous of may become apparent from this disclosure.

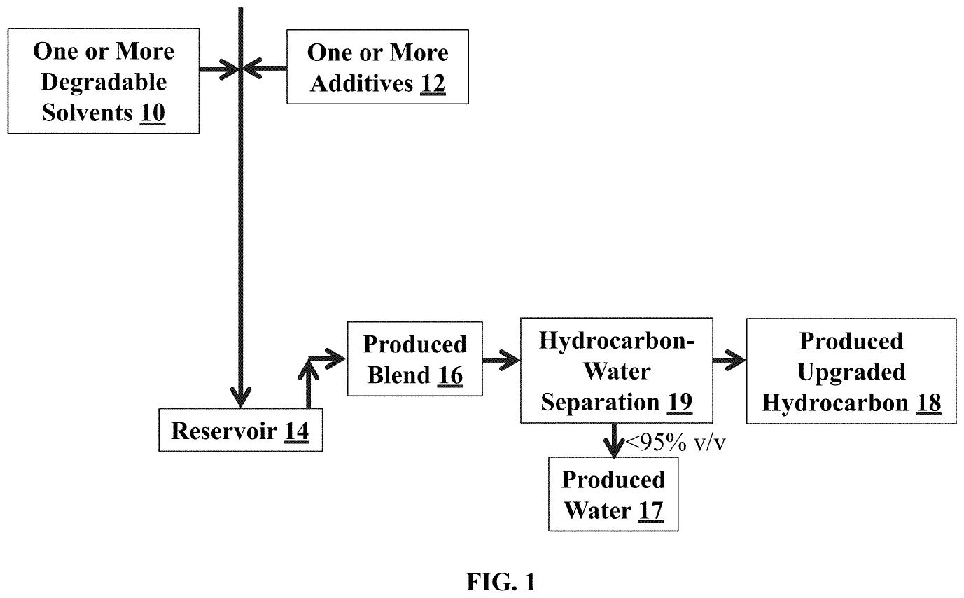

In one embodiment, referring to FIG. 1, a volume of one or more degradable solvents 10 and a volume of one or more additives 12 are injected, such as co-injected, into an injection well drilled in a reservoir 14 that includes heavy hydrocarbon. The volume of the one or more degradable solvents 10 may be provided from one or more tanks and injected into the injection well via a manifold or tree into the reservoir 14 at a desired ratio of the one or more degradable solvents to upgraded hydrocarbon produced. Similarly, the volume of the one or more additives 12 may be provided from one or more tanks and injected into the injection well via a manifold or tree into the reservoir 14 at a desired ratio of the one or more additives 12 to the one or more degradable solvents 10.

The one or more degradable solvents 10 are injected into the reservoir 14, for example, at a ratio by volume of the one or more degradable solvents 10 to the upgraded hydrocarbon produced of from 0.05:1 to 0.15:1 (e.g., of from 0.05 vol/vol to 0.15 vol/vol) or other options provided herein. The ratio of the one or more degradable solvents 10 to the upgraded hydrocarbon produced is expressed herein as volume/volume (v/v).

The one or more additives 12 are injected into the reservoir 14 at a ratio by weight of the one or more additives 12 to the one or more degradable solvents 10 of from 10 ppm:1 to 6500 ppm:1 or other options provided herein. For the purposes of this disclosure, the ratio is measured as weight/weight, i.e., milligrams of additive(s)/kilograms of degradable solvent(s) in the laboratory. In the field, the ratio may be expressed as kilogram of additive(s)/1000 Ton (1000 kilograms) of degradable solvent(s).

The one or more degradable solvents 10 may be injected at reservoir temperature such as ambient temperature. Alternatively, the one or more degradable solvents 10 may be warmed and they may be injected into the injection well without the use of steam. In one embodiment, the temperature of the warmed one or more degradable solvents 10 when injected into the injection well may be higher than the reservoir temperature and less than 200° C. without the use of steam. In one embodiment, the temperature of the warmed one or more degradable solvents 10 when injected into the injection well is of from 10° C. to 200° C. above the reservoir temperature. The one or more degradable solvents 10 may be warmed using a conventional heater for heating fluid.

The one or more degradable solvents 10 and the one or more additives 12 are injected into the reservoir 14 to induce in situ upgrading of the heavy hydrocarbon in the reservoir 14 to increase the API gravity and lower the viscosity of the heavy hydrocarbon in the reservoir 14 to increase oil production rates without steam injection. In some embodiments, the initial API gravity of the heavy hydrocarbon is of from 8 API to 14 API, and the increased API gravity of the upgraded hydrocarbon is of from 16 to 25. In some embodiments, the initial viscosity of the heavy hydrocarbon is of from 100,000 cSt at 40° C. to 25,000 cSt at 40° C., and the decreased viscosity of the upgraded hydrocarbon is of from 150 cSt at 40° C. to 370 cSt at 40° C. For example, the upgraded hydrocarbon may have a minimum of 17 API vs. an original API of about 14 API (see FIG. 12), and two- to three-fold reduction of viscosity making it transportable using pipelines (e.g., a viscosity of about 366 cSt at 40° C. vs. an original viscosity of 29,025 cSt at 40° C., see FIG. 15) without steam injection and expensive surface upgrader facilities.

A blend is formed in the reservoir 14 and contains at least a portion of the upgraded hydrocarbon formed in the reservoir 14. For example, following a desired injection time, the production well in the reservoir 14 is then operated at production conditions, e.g., reservoir conditions, to produce a produced blend 16 containing at least a portion of the upgraded hydrocarbon formed in the reservoir 14.

The produced blend 16 may also include at least a portion of the one or more degradable solvents 10 injected into the reservoir 14. The produced blend 16 may also include at least a portion of the one or more additives 12 injected into the reservoir 14. The produced blend 16 can further contain produced water and gas.

The produced blend 16 may be separated in a topside facility, e.g., by hydrocarbon-water separation 19 such as a separator, to provide a produced upgraded hydrocarbon 18 having the desired improved characteristics. The produced water can also be separated using the hydrocarbon-water separation 19 as produced water 17. Practically any device and any technique in the art for hydrocarbon-water separation may be utilized (e.g., decantation, filtration, distillation, liquid-liquid separation, centrifugation. or any combination thereof).

In FIG. 1, the portion of the one or more degradable solvents 10 that is produced simply remains in the produced upgraded hydrocarbon 18 and the produced upgraded hydrocarbon 18 is sent for further processing (e.g., refining). As an example, the one or more degradable solvents 10 have no impact on downstream operations as they are composed mainly of hydrocarbons with very little oxygen-containing compounds. Similarly, the portion of the one or more additives 12, if any, that is produced simply remains in the produced upgraded hydrocarbon 18 and the produced upgraded hydrocarbon 18 is sent for further processing.

The downhole injection can be carried out using conventional pumps used in petroleum field applications. The wells positioned in the reservoir 14 are well known and can include, by way of example, vertical, horizontal, slanted wells or multilateral wells having multiple lateral wells connected to a main wellbore. The process depicted in FIG. 1 can be carried out in a continuous mode by using two wells. One well for injecting the one or more degradable solvent 10 and the one or more additives 12, and the other well for production of the upgraded hydrocarbon. In this way, the operation of the process is facilitated, increasing economic prospects. This continuous process is known as solvent flooding. The use of well arrays (e.g., 5- or 7 spots) is also possible to maximize production of upgraded hydrocarbon and reservoir sweep.

Similarly, this process can be accomplished in a discontinuous mode (also known as cyclic solvent stimulation (CSvS)) by injecting a fixed amount of the one or more degradable solvents 10 and a fixed amount of the one or more additives 12, and after a soaking time (e.g., from 1 day to 1 week), producing the upgraded hydrocarbon.

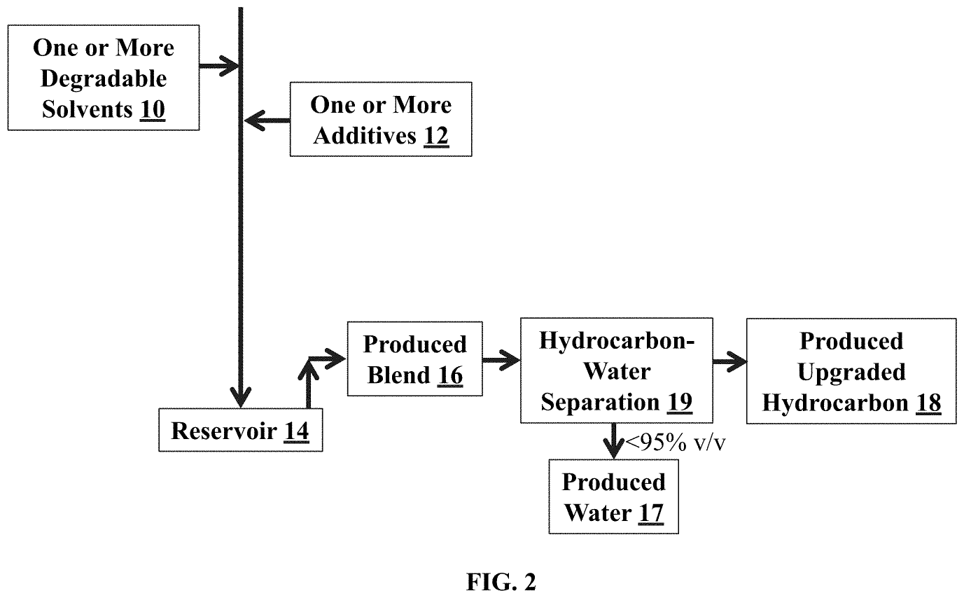

In one embodiment, as shown in FIG. 2, similar to the process shown in FIG. 1, the process for in situ upgrading of a heavy hydrocarbon in a reservoir involves injecting the one or more additives 12 into the reservoir 14 before injecting the one or more degradable solvents 10 into the reservoir 14. For example, the one or more additives 12 may be injected before the one or more degradable solvents 10 to reduce or prevent degradation of the one or more degradable solvents 10 by sulfate-reducing bacteria, slime-forming bacteria, iron-oxidizing bacteria, etc.

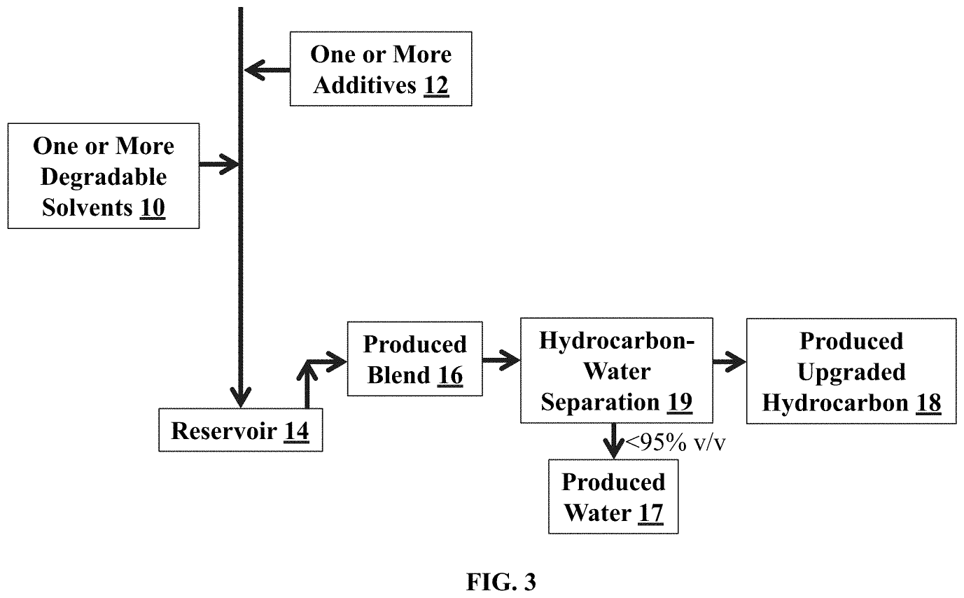

In one embodiment, as shown in FIG. 3, similar to the process shown in FIG. 1, the process for in situ upgrading of a heavy hydrocarbon in a reservoir involves injecting the one or more degradable solvents 10 into the reservoir 14 before injecting the one or more additives 12 into the reservoir 14. For example, if a degradable solvent A is injected on day 1 and a biocide and/or other additive is injected on day 30, the degradable solvent A on day 30 may already have been eaten by bacteria, emulsions may have formed (which may negatively affect operations due to higher viscosity), corrosion may have increased, etc. Thus, in one embodiment, the one or more additives 12 may be injected within 24 hours of injecting the one or degradable solvents 10 in order to protect the one or more degradable solvents 10.

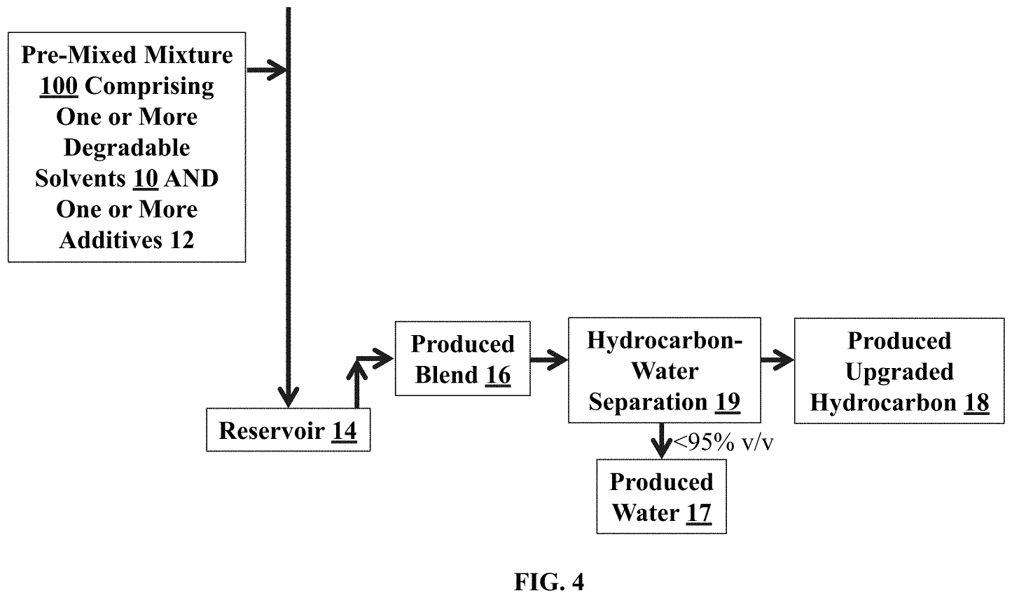

In one embodiment, as shown in FIG. 4, similar to the process shown in FIG. 1, the process for in situ upgrading of a heavy hydrocarbon in a reservoir involves injecting a pre-mixed mixture 100 comprising the one or more degradable solvents 10 and the one or more additives 12 into the reservoir 14. The pre-mixed mixture 100 may be provided from a tank and injected into the injection well via a manifold or tree into the reservoir 14 at a desired ratio of the one or more degradable solvents to upgraded hydrocarbon produced and at a desired ratio of the one or more additives to the one or more degradable solvents. By doing so, the two injection streams in FIGS. 1-3 may be reduced to one injection stream in FIG. 4.

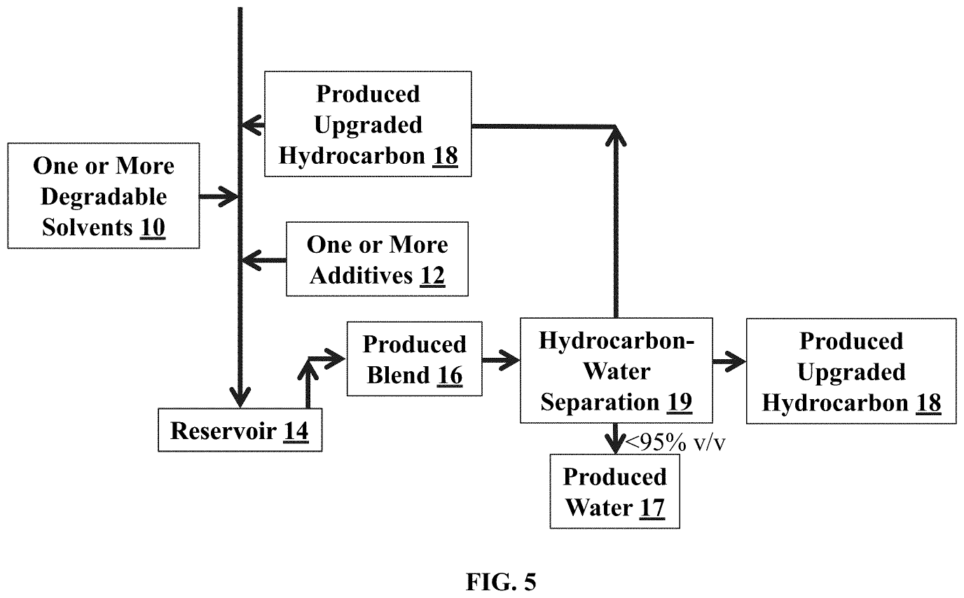

In one embodiment, as shown in FIG. 5, similar to the process shown in FIG. 1, the process for in situ upgrading of a heavy hydrocarbon in a reservoir involves removing at least a portion of the upgraded hydrocarbon from the produced blend (as the removed upgraded hydrocarbon comprises at least a portion of the one or more degradable solvents 10 injected into the reservoir). The process also includes injecting the removed upgraded hydrocarbon into the injection well. In FIG. 5, the removed upgraded hydrocarbon is not co-injected, but it could be co-injected.

In FIG. 5, the produced blend 16 is separated in the topside facility, e.g., the hydrocarbon-water separation 19 such as a separator, into (a) the produced upgraded hydrocarbon 18 having at least a portion of the one or more degradable solvents 10 injected into the injection well and (b) the produced water 17. The produced upgraded hydrocarbon 18 having the one or more degradable solvents 10 that is removed (e.g., up to 90% vol/vol) from the produced blend 16 may be injected into the injection well, a different injection well, or any combination thereof.

In one embodiment, some of the produced upgraded hydrocarbon 18 having the one or more degradable solvents 10 may be re-injected (e.g., >80 vol %), and the rest of the produced upgraded hydrocarbon 18 having the one or more degradable solvents 10 may simply be sent for further processing (e.g., <20 vol %) as illustrated in FIG. 5. As an example, in the discontinuous mode, the one or more degradable solvents can be easily recovered and recycled by injecting the first volumes of the produced upgraded hydrocarbon, which is composed of mainly degradable solvent(s) (e.g., >80 vol %). In this way, no distillation procedure is needed with the concomitant economic benefits.

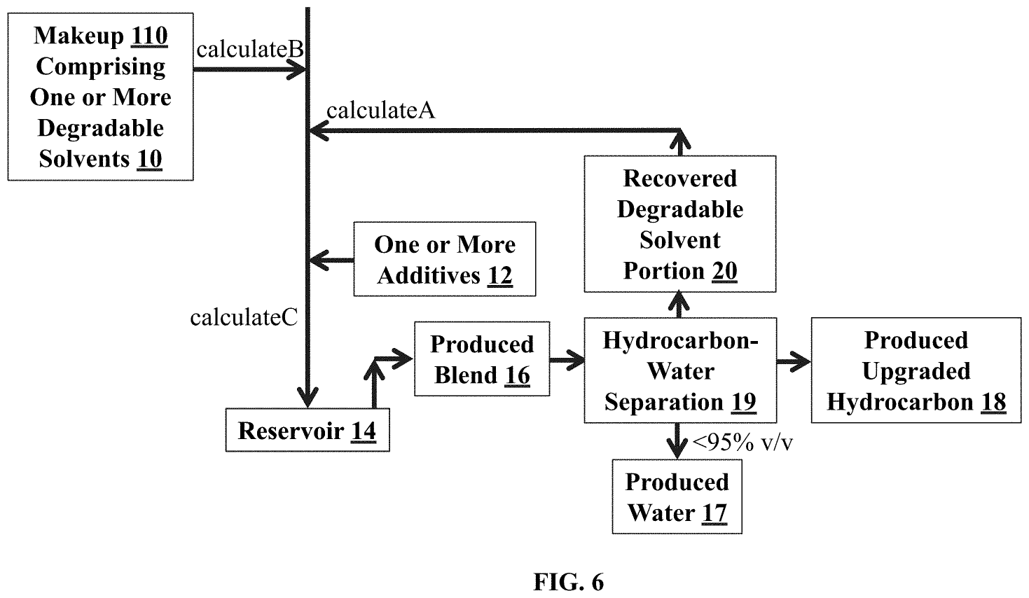

In one embodiment, as shown in FIG. 6, similar to the process shown in FIG. 1, the process for in situ upgrading of a heavy hydrocarbon in a reservoir involves removing at least a portion (e.g., up to 90% vol/vol) of the one or more degradable solvents from the produced blend and injecting the removed one or more degradable solvents into the injection well, a different injection well, or any combination thereof. In FIG. 6, the removed one or more degradable solvents are not co-injected, but they could be co-injected.

In FIG. 6, the produced blend 16 is separated in the topside facility, e.g., the hydrocarbon-water separation 19 such as a separator, into the produced upgraded hydrocarbon 18, a recovered degradable solvent portion 20 comprising the one or more degradable solvents 10, and the produced water 17. The removed one or more degradable solvents 10 may be injected into the injection well. The one or more additives 12, if any, in the produced upgraded hydrocarbon 18 may simply remain in the produced upgraded hydrocarbon 18. The produced upgraded hydrocarbon 18 with the one or more additives 12, if any, may be sent for further processing (e.g., refining).

Moreover, makeup 110 comprising one or more degradable solvents 10 may be injected (e.g., before, after, or co-injected with the recovered degradable solvent portion 20) into the injection well so that a target amount of the one or more degradable solvents 10 is injected into the reservoir 14. The one or more degradable solvent 10 may be separated from the produced upgraded hydrocarbon and recycled by injection back into the injection well. Thus, a small amount (e.g., <10 vol %) of the makeup 110 of the one or more degradable solvent 10 is utilized to continue the process with the concomitant increase in the economic benefits. This type of recycling may be implemented in cyclic solvent stimulation or solvent flooding modes. In one embodiment, the makeup 110 may include one or more additives 12 to reach the target amount of the one or more additives 12.

Regarding the makeup 110, as illustrated in FIG. 6, one or more calculations may be performed to determine the amount of the recovered degradable solvent portion 20 (e.g., 90% of the volume injected—calculateA) before injection as well as to determine the amount of the makeup 110 of the one or more degradable solvents 10 to inject to reach the target amount of the one or more degradable solvents 10 (e.g., 10% of the volume injected—calculateB). Optionally, the amount of the one or more degradable solvents from the two injection streams may be checked to confirm that the target amount of the one or more degradable solvents 10 is being injected (e.g., 100% of the volume injected—calculateC). Sensors, measurement devices, and techniques in the art for determining the amount of solvent(s) in a stream may be utilized for the calculations. CalculateA, calculateB, and/or calculateC may be performed at other locations in some embodiments.

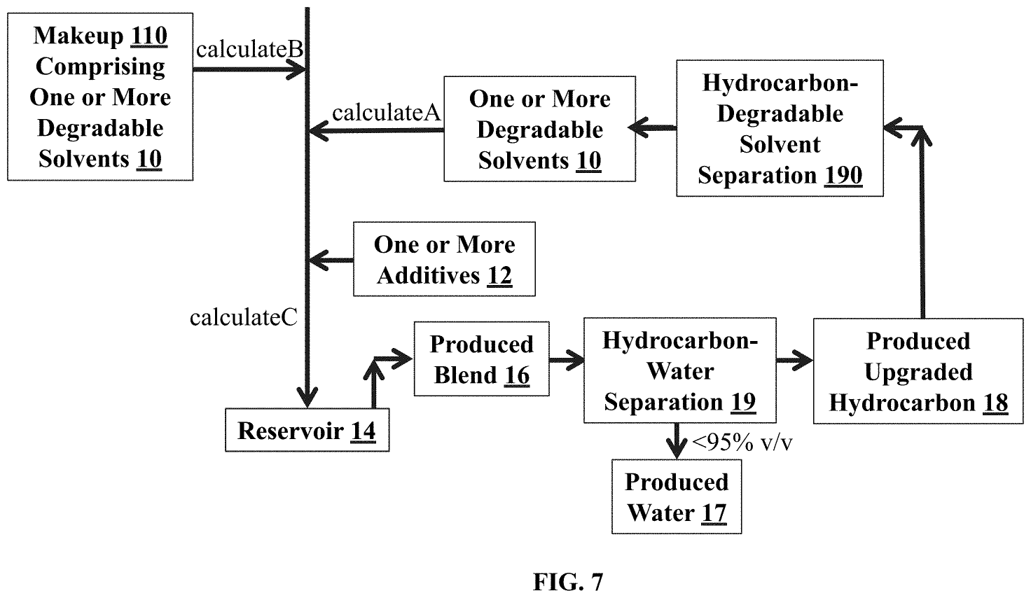

In one embodiment, as shown in FIG. 7, similar to the process shown in FIG. 6, the process for in situ upgrading of a heavy hydrocarbon in a reservoir involves removing at least a portion of the one or more degradable solvents from the produced blend and injecting the removed one or more degradable solvents into the injection well. For example, hydrocarbon-degradable solvent separation (e.g., distillation, flash evaporation, or any combination thereof) is utilized for removing the one or more degradable solvents from the produced blend 16 up to 90% vol/vol of the degradable solvent volume injected (calculateC).

In FIG. 7, the produced blend 16 is separated in the topside facility, e.g., the hydrocarbon-water separation 19 such as a separator, into the produced upgraded hydrocarbon 18 comprising the one or more degradable solvents 10 and the produced water 17. The hydrocarbon-degradable solvent separation 190, such as distillation, is further utilized to separate the one or more degradable solvents 10 from the produced upgraded hydrocarbon 18. The removed one or more degradable solvents 10 may be recycled by injection back into the injection well. Furthermore, the makeup 110, the calculations, the injection of the one or more additives 12, etc. may proceed as described in FIG. 6.

As illustrated in FIG. 7, the one or more degradable solvents 10 from the produced upgraded hydrocarbon 18 may be removed (e.g., up to 90% vol/vol) and recycled by injection back into the injection well. For example, the one or more degradable solvents 10 may comprise hydrocarbons that are completely miscible in the produced upgraded hydrocarbon 18, and distillation (e.g., atmospheric and vacuum distillations) and/or flash evaporation may be utilized to remove the one or more degradable solvents 10 from the produced upgraded hydrocarbon 18. The removed one or more degradable solvents 10 may be injected into the injection well. For example, the produced upgraded hydrocarbon 18 can contain less than 100 ppm of the one or more additives 12. The one or more additives 12, if any, in the produced upgraded hydrocarbon 18 may simply remain in the produced upgraded hydrocarbon 18. The produced upgraded hydrocarbon 18 with the one or more additives 12, if any, may be sent for further processing (e.g., refining). This advantageously avoids the need for additional wells, be they horizontal wells or otherwise, and serves to minimize the amount of degradable solvent or other additive injection, and provides for ease in recovery and recycling of same. Thus, the process of the present invention is advantageous in terms of cost of equipment, raw materials and labor. Furthermore, the present disclosure advantageously provides for upgrading and production of heavy hydrocarbons which cannot otherwise be economically produced.

Of note, regarding recycling of the degradable solvents or the upgraded hydrocarbon containing the degradable solvents as in FIGS. 6-7, if all the degradable solvents are removed, then the API uplift may be impacted and/or the viscosity decrease may be impacted. Thus, in some embodiment, at least about 10% of the degradable solvents may be left in the produced upgraded hydrocarbon for the API increase and the viscosity decrease. Thus, in some embodiments, of from 0% vol/vol to 90% vol/vol of the one or more degradable solvents 10 may be removed from the produced blend 16.

Various embodiments are provided hereinabove for injecting the one or more degradable solvents and the one or more additives for in situ upgrading of heavy oil without steam injection. However, modifications may be made to the embodiments provided herein. For example, the one or more degradable solvents 10 may be injected at reservoir temperature or warmed in the embodiments that are illustrated in FIGS. 1-7. As another example, one or more non-condensable gases may be injected (e.g., co-injected with the one or more degradable solvents) to reduce or prevent loss of the one or more degradable solvents in the embodiments that are illustrated in FIGS. 1-7. As another example, different arrays of injection and production wells can be envisioned such as one injection well in the center surrounded by multiple production wells (e.g., of from 4 to 8 production wells). The reverse configuration is also possible, i.e., one production well surrounded by multiple injection wells (e.g., of from 4 to 8 injection wells).

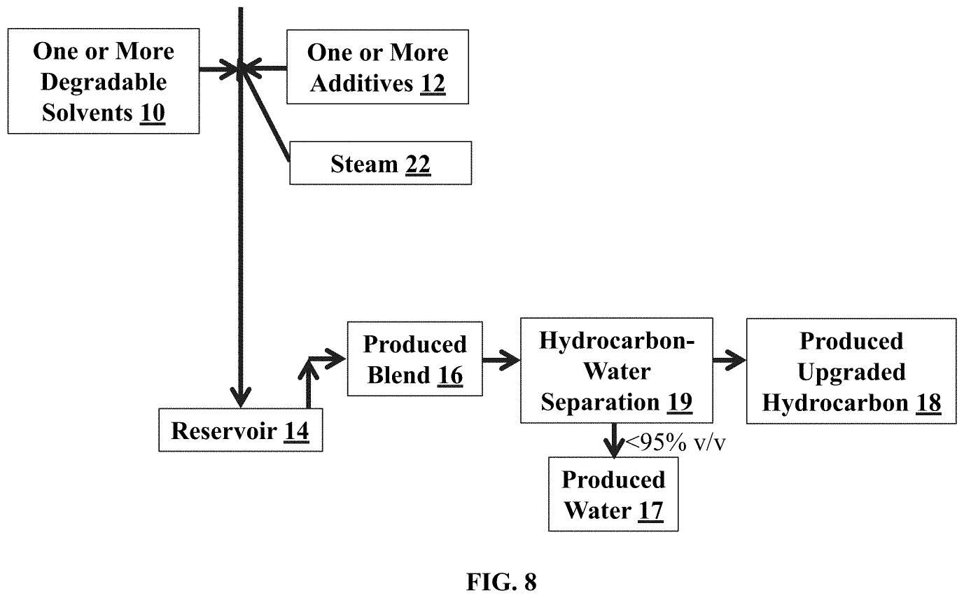

OPTIONAL STEAM INJECTION: If steam injection is desired, less steam as compared to conventional techniques can be injected according to embodiments provided herein. In one embodiment, as shown in FIG. 8, similar to the process shown in FIG. 1, the process for in situ upgrading of a heavy hydrocarbon further involves injecting steam 22 via a manifold or tree into a horizontal well in a SAGD configuration into the reservoir 14 containing the heavy hydrocarbon under reservoir conditions. The one or more additives 12 may condense with the steam 22 in the reservoir 14. The embodiments illustrated in FIGS. 2-7 may also be modified to inject the steam 22 as desired, such as (i) before, after, or co-injected with the one or more degradable solvents 10, (ii) before, after, or co-injected with the one or more additives 12, (iii) or any combination thereof.

In FIG. 8, the total amount of steam that may be injected is 5% vol/vol to 30% vol/vol (e.g., 10% vol/vol or 5% vol/vol to 15% vol/vol), which is a lower amount of steam as compared to conventional steam injection. The produced water 17 produced from the reservoir 14 can optionally provide the water to form the steam 22. Likewise, the produced upgraded hydrocarbon 18 produced from the reservoir 14 can optionally be used as fuel to generate the steam 22. In one embodiment, the steam 22 is co-injected at a temperature of from the reservoir temperature to 300° C. into the injection well with the one or more degradable solvents 10 and/or the one or more additives 12. In one embodiment, the steam 22 is injected at a temperature of from the reservoir temperature to 300° C. into the injection well in any order with the one or more degradable solvents 10 and/or the one or more additives 12.

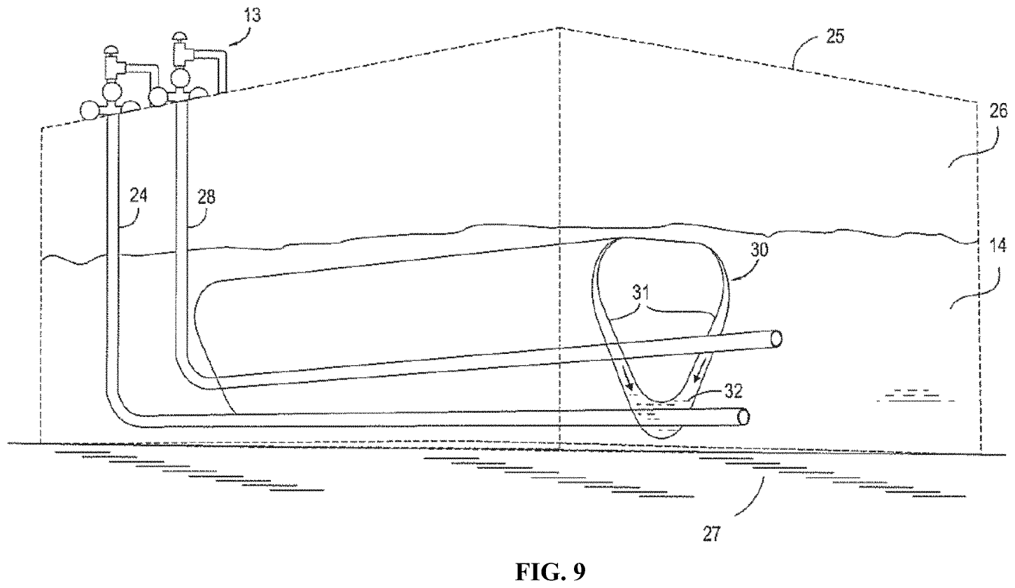

In a SAGD well configuration, there is a top horizontal injection well (also referred to as an injector) and a parallel bottom horizontal production well (also referred to as a producer). In a standard SAGD configuration, referring to FIG. 9, the horizontal production well 24 is drilled into the reservoir 14 penetrating the surface of the earth 25 and overburden materials 26. The reservoir 14 is bounded on the top and bottom by one surface, the bottom of the overburden 26, and by another surface, the top of the understratum 27. Above the reservoir 14 is the overburden 26, which is of any one or more of shale, rock, sand layers, etc. The horizontal injection well 28, typically aligned vertically between 5 and 10 meters above the production well 24 is also drilled into the reservoir 14. In one embodiment, the steam, the degradable solvent(s), and the additive(s) are injected into the reservoir 14 through the manifold or tree 13 into the injection well 28 and flow into the steam depletion chamber 30. In substantially vapor form, the steam, the degradable solvent(s), and the additive(s) may flow to the edges 31 of the chamber 30, condense at approximately the same location, and deliver their latent heat to the tar sand within the reservoir. As reservoir fluids 32 (also referred to herein as the produced blend, including the upgraded hydrocarbon, the degradable solvent(s), the additive(s), and the produced water) are produced to the surface with the production well 24, the steam chamber 30 expands further into the reservoir 14. The injected steam acts to deliver both heat and pressure to the reservoir 14. After the heavy hydrocarbon in the reservoir is heated, its viscosity falls, it becomes more mobile, and it flows under gravity to the production well 24, as in conventional SAGD. The additive(s) advantageously allow the combined steam and degradable solvent(s) to travel at least 10 meters, even at least 30 meters, and even at least 70 meters from the injection well 28, thus enhancing production. As in previously discussed embodiments, at a topside facility (not shown), the upgraded hydrocarbon, the degradable solvent(s), and the produced water are separated to form the produced upgraded hydrocarbon.

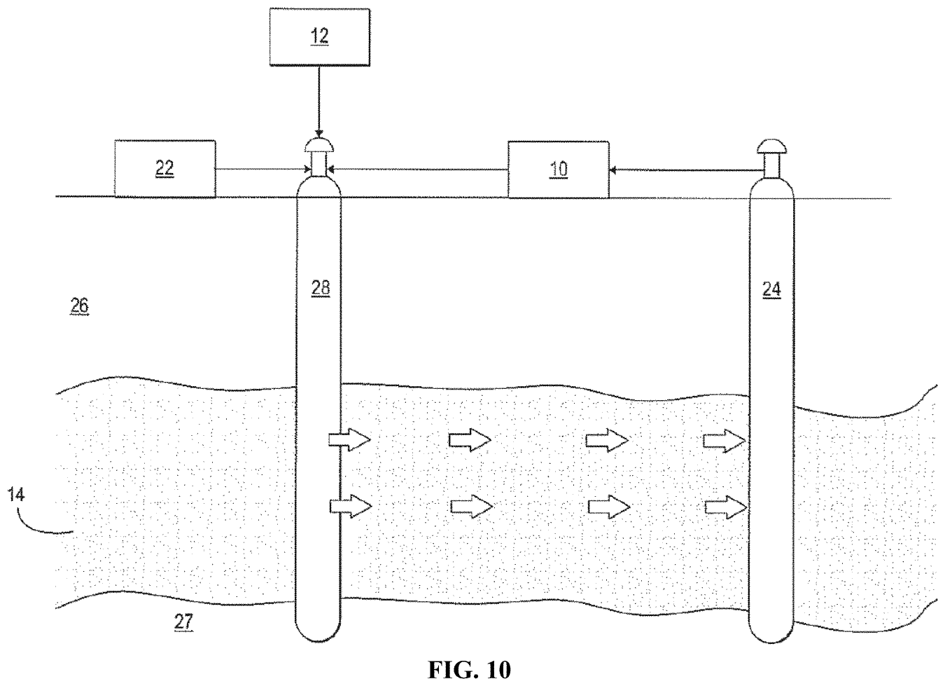

In one embodiment, as illustrated in FIG. 10, the process for in situ upgrading of a heavy hydrocarbon in a reservoir utilizes spaced vertical wells. The steam, the degradable solvent(s), and the additive(s) are injected into the reservoir 14 through the injection well 28 and flow horizontally toward the production well 24. Again, the reservoir 14 is bounded on the top and bottom by one surface, the bottom of the overburden 26, and by another surface, the top of the understratum 27. The vertical injection well 28 is typically spaced at least 10 meters from the production well 24. Using the additive(s) 12 as disclosed herein, the steam, the degradable solvent(s), and the additive(s) may travel at least 10 meters in the vapor phase within the reservoir 14.

In one embodiment, once the upgraded hydrocarbon has been produced, the upgraded hydrocarbon can first be transported by way of, for example, a pipeline, and then further transported by another transportation carrier to a desired location such as a refinery. For example, the upgraded hydrocarbon can be transported through a pipeline to a ship terminal where the upgraded hydrocarbon is then further transported on a ship to a desired refinery.

EXAMPLES: The following non-limiting examples are illustrative of embodiments of the present disclosure.

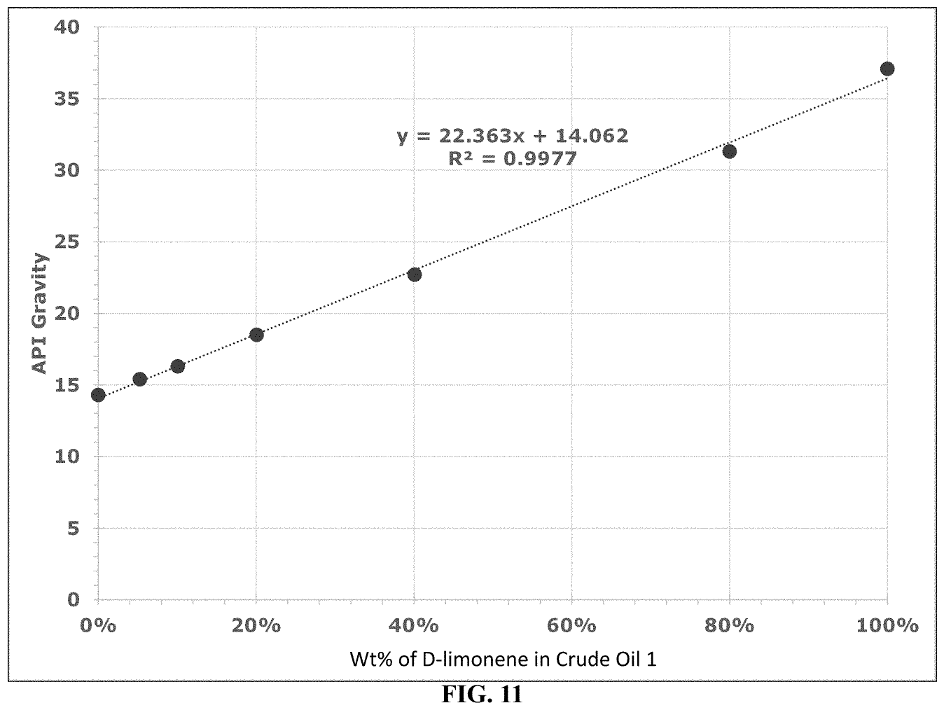

Example 1: FIG. 11 illustrates the effect of the degradable solvent d-limonene on the API gravity of Crude Oil 1. Samples were prepared with varying amounts of the degradable solvent d-limonene (e.g., from 5% wt./wt. to 80% wt./wt.) at 25° C. in Crude Oil 1. The API gravity of each sample was analyzed using ASTM D4052-18a. The initial API gravity was 14. As illustrated in FIG. 11, the API gravity of the Crude Oil 1/d-limonene samples increased as the wt. % of d-limonene increased in the Crude Oil 1.

Example 2: FIG. 12 illustrates the effect of the degradable solvent beta-pinene on the API gravity of Crude Oil 1. Samples were prepared with varying amounts of the degradable solvent beta-pinene (e.g., from 5% wt./wt. to 80% wt./wt.) at 25° C. in Crude Oil 1. The API gravity of each sample was analyzed using ASTM D4052-18a. The initial API gravity was 14. As illustrated in FIG. 12, the API gravity of the Crude Oil 1/beta-pinene samples increased as the wt. % of beta-pinene increased in the Crude Oil 1.

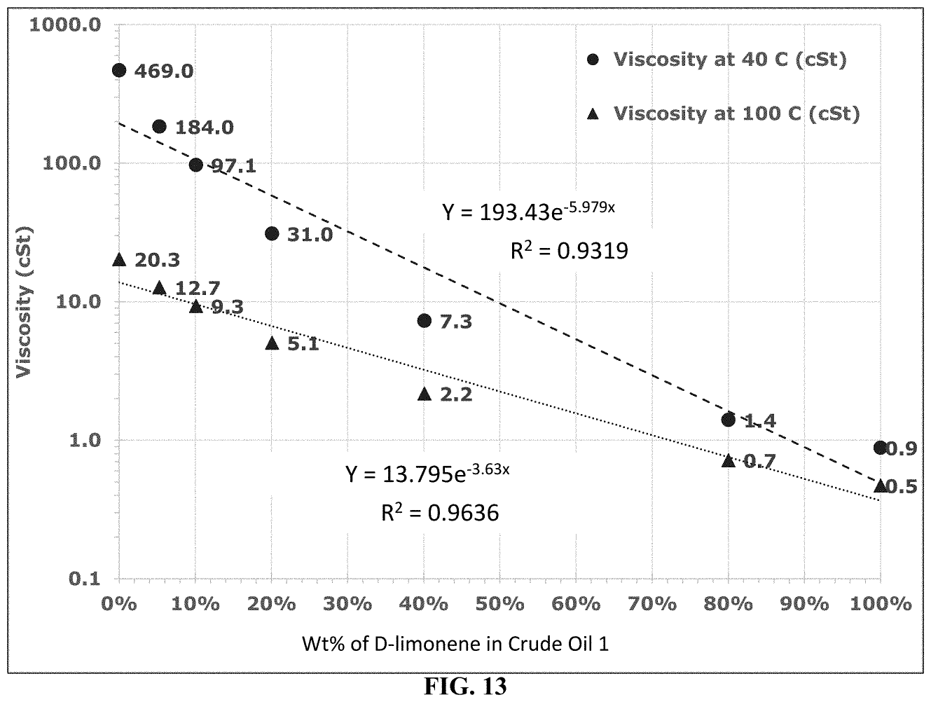

Example 3: FIG. 13 illustrates the effect of the degradable solvent d-limonene on the viscosity of Crude Oil 1. Samples were prepared with varying amounts of the degradable solvent d-limonene (e.g., from 5% wt./wt. to 80% wt./wt.) at 25° C. in Crude Oil 1. The viscosity of each sample was analyzed using ASTM D 445-06 at 40° C. and 100° C. The initial viscosity is 469.0 cSt at 40° C. and 20.3 cSt at 100° C. As illustrated in FIG. 13, the viscosity of the Crude Oil 1/d-limonene samples decreased at the corresponding temperature of 40° C. or 100° C. as the wt. % of d-limonene increased in the Crude Oil 1.

Indeed, for Example 3 corresponding to FIG. 13, several blends of Crude Oil 1 (API=14° API) were prepared in the range from 5 wt % to 80 wt % of d-limonene. The blends were sonicated to make sure both components were mixed properly. FIG. 13 illustrates the viscosity of the Crude Oil 1-D-limonene mixtures at two different temperatures. As seen, the addition of small quantities (e.g., <10 wt %) of the degradable solvent d-limonene led to viscosity reductions in the order of 70-80% and 50-60% at 40° C. and 100° C., respectively. Using 20 wt. % of degradable solvent d-limonene, viscosity reductions were ˜90%. These values illustrate the advantages of using one or more degradable solvents for EOR of heavy oils without steam.

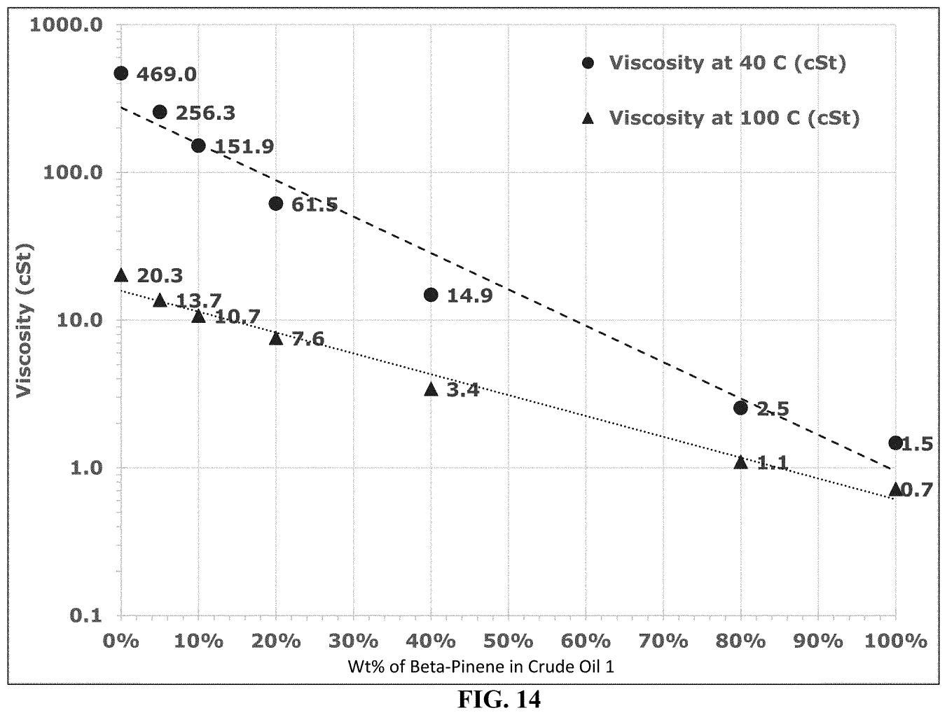

Example 4: FIG. 14 illustrates the effect of the degradable solvent beta-pinene on the viscosity of Crude Oil 1. Samples were prepared with varying amounts of the degradable solvent beta-pinene from 5% wt./wt. to 80% wt./wt.) at 25° C. in Crude Oil 1. The viscosity of each sample was analyzed using ASTM D 445-06 at 40° C. and 100° C. The initial viscosity is 469.0 cSt at 40° C. and 20.3 cSt at 100° C. As illustrated in FIG. 14, the viscosity of the Crude Oil 1 decreased at the corresponding temperature of 40° C. or 100° C. as the wt. % of beta-pinene increased in the Crude Oil 1.

Example 5: FIG. 15 illustrates the effect of the degradable solvent d-limonene on the viscosity of Crude Oil 2. Samples were prepared with varying amounts of the degradable solvent d-limonene from 5% wt./wt. to 80% wt./wt.) at 25° C. in Crude Oil 2. The viscosity of each sample was analyzed using ASTM D 445-06 at 40° C. and 100° C. The initial viscosity is 29025.0 cSt at 40° C. and 215.5 cSt at 100° C. As illustrated in FIG. 15, the viscosity of the Crude Oil 2 decreased at the corresponding temperature of 40° C. or 100° C. as the wt % of d-limonene increased in the Crude Oil 2.

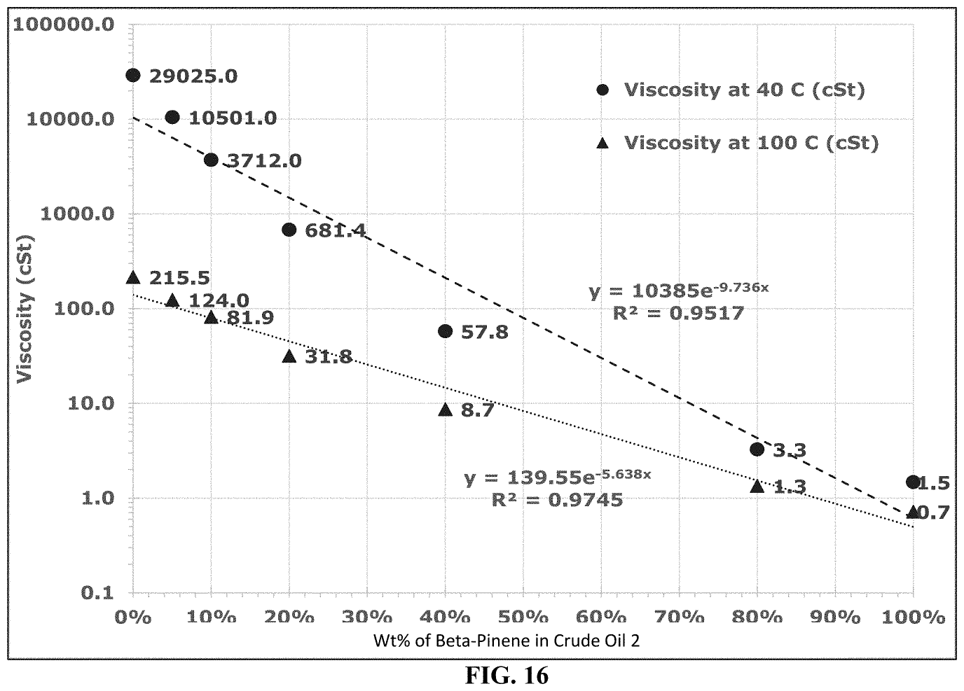

Example 6: FIG. 16 illustrates the effect of the degradable solvent beta-pinene on the viscosity of Crude Oil 2. Samples were prepared with varying amounts of the degradable solvent beta-pinene from 5% wt./wt. to 80% wt./wt.) at 25° C. in Crude Oil 2. The viscosity of each sample was analyzed using ASTM D 445-06 at 40° C. and 100° C. The initial viscosity is 29025.0 cSt at 40° C. and 215.5 cSt at 100° C. As illustrated in FIG. 16, the viscosity of the Crude Oil 2 decreased at the corresponding temperature of 40° C. or 100° C. as the wt. % of beta-pinene increased in the Crude Oil 2.

As illustrated at FIGS. 13-16 for Examples 3-6, the addition of small quantities of a degradable solvent (e.g., <10%) to Crude Oil 1 and Crude Oil 2 led to viscosity reductions in the 75-90% at 40° C. and viscosity reductions in the 60-80% range at 100° C.

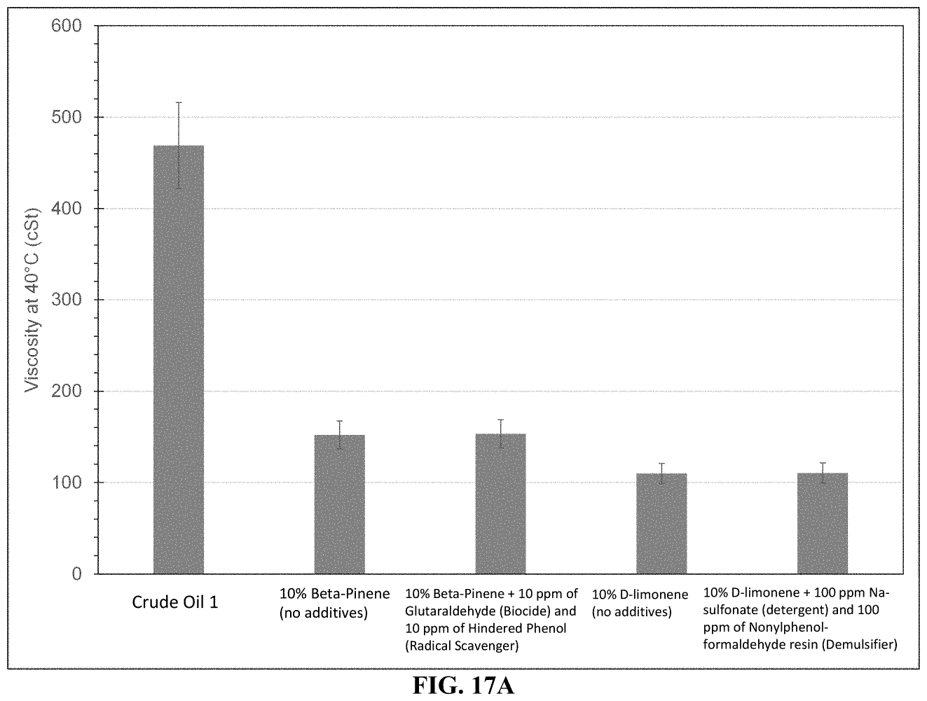

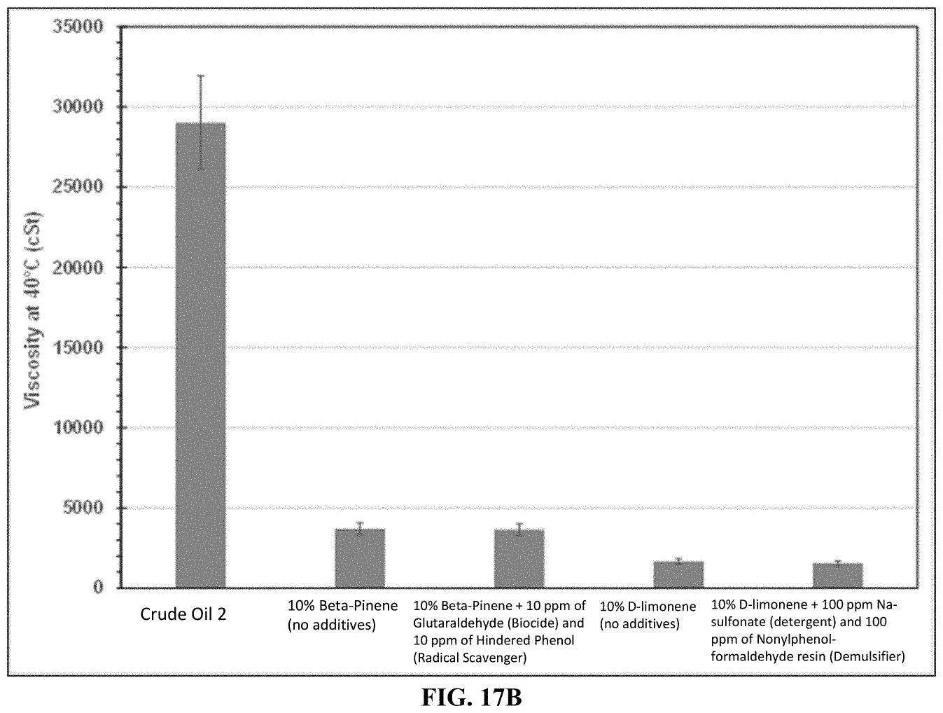

Example 7: FIG. 17A illustrates the effect of additives on the viscosity of degradable solvents and Crude Oil 1. The first bar illustrates the viscosity of Crude Oil 1 at 40° C. without the addition of a degradable solvent and without the addition of an additive.

The second bar illustrates the viscosity of a second sample that was prepared by adding 10 g of the degradable solvent beta-pinene to 90 g of Crude Oil 1 (i.e., 10% wt./wt. beta-pinene). No additive was used for this second sample.

The third bar illustrates the viscosity of a third sample that was prepared by adding 10 g of the degradable solvent beta-pinene, 10 ppm of a biocide, and 10 ppm of a radical scavenger to 90 g of Crude Oil 1 (i.e., 10% wt./wt. beta-pinene). For the third sample, the additives were dissolved in the degradable solvent and then this mixture was added to the Crude Oil 1. The reduction in viscosity of the second and third samples appears to be the result of the degradable solvent beta-pinene instead of the presence of the additives. Thus, the two additives did not substantially impact the viscosity of the third sample in a negative manner, and the two additives can still provide the advantages discussed herein.

The fourth bar illustrates the viscosity of a fourth sample that was prepared by adding 10 g of the degradable solvent d-limonene to 90 g of Crude Oil 1 (i.e., 10% wt./wt. d-limonene), but an additive was not added to this fourth sample.

The fifth bar illustrates the viscosity of a fifth sample that was prepared by adding 10 g of the degradable solvent d-limonene, 100 ppm of a detergent, and 100 ppm of a demulsifier to 90 g of Crude Oil 1 (i.e., 10% wt./wt. d-limonene). For the fifth sample, the additives were dissolved in the degradable solvent and then this mixture was added to the Crude Oil 1. The reduction in viscosity of the fourth and fifth samples appears to be the result of the degradable solvent d-limonene instead of the presence of the additives. Thus, the two additives did not substantially impact the viscosity of the fifth samples in a negative manner, and the two additives can still provide the advantages discussed herein.

Similar to FIG. 17A with Crude Oil 1, FIG. 17B illustrates the effect of additives on the viscosity of degradable solvents (pinene and limonene) using Crude Oil 2. The first bar illustrates the viscosity of Crude Oil 2 at 40° C. without the addition of a degradable solvent and without the addition of an additive.

The second bar illustrates the viscosity of a second sample that was prepared by adding 10 g of the degradable solvent beta-pinene to 90 g of Crude Oil 2 (i.e., 10% wt./wt. beta-pinene). No additive was used for this second sample.

The third bar illustrates the viscosity of a third sample that was prepared by adding 10 g of the degradable solvent beta-pinene, 10 ppm of a biocide, and 10 ppm of a radical scavenger to 90 g of Crude Oil 2 (i.e., 10% wt./wt. beta-pinene). For the third sample, the additives were dissolved in the degradable solvent and then this mixture was added to the Crude Oil 2. The reduction in viscosity of the second and third samples appears to be the result of the degradable solvent beta-pinene instead of the presence of the additives. Thus, the two additives did not substantially impact the viscosity of the third sample in a negative manner, and the two additives can still provide the advantages discussed herein.

The fourth bar illustrates the viscosity of a fourth sample that was prepared by adding 10 g of the degradable solvent d-limonene to 90 g of Crude Oil 2 (i.e., 10% wt./wt. d-limonene), but an additive was not added to this fourth sample.

The fifth bar illustrates the viscosity of a fifth sample that was prepared by adding 10 g of the degradable solvent d-limonene, 100 ppm of a detergent, and 100 ppm of a demulsifier to 90 g of Crude Oil 2 (i.e., 10% wt./wt. d-limonene). For the fifth sample, the additives were dissolved in the degradable solvent and then this mixture was added to the Crude Oil 2. The reduction in viscosity of the fourth and fifth samples appears to be the result of the degradable solvent d-limonene instead of the presence of the additives. Thus, the two additives did not substantially impact the viscosity of the fifth samples in a negative manner, and the two additives can still provide the advantages discussed herein.

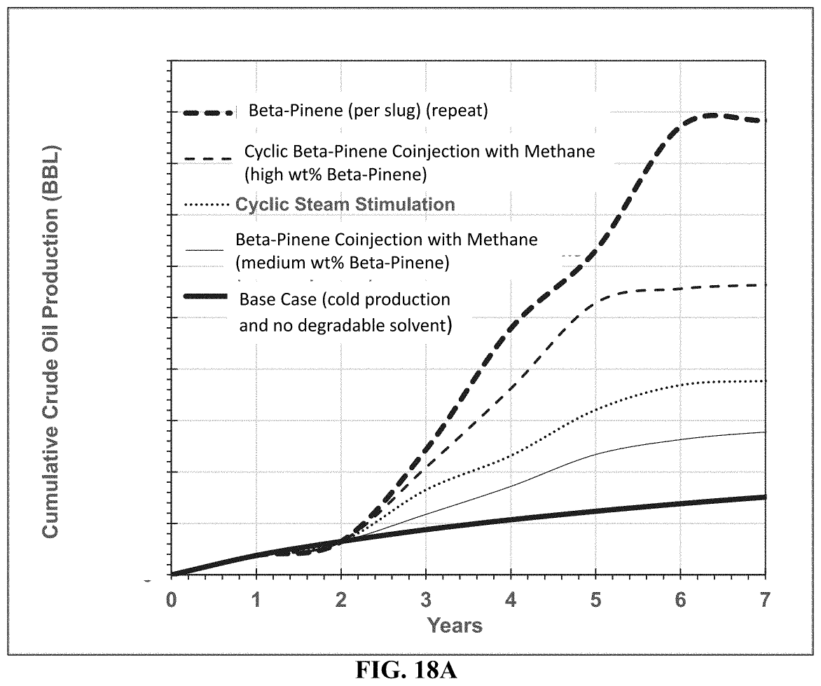

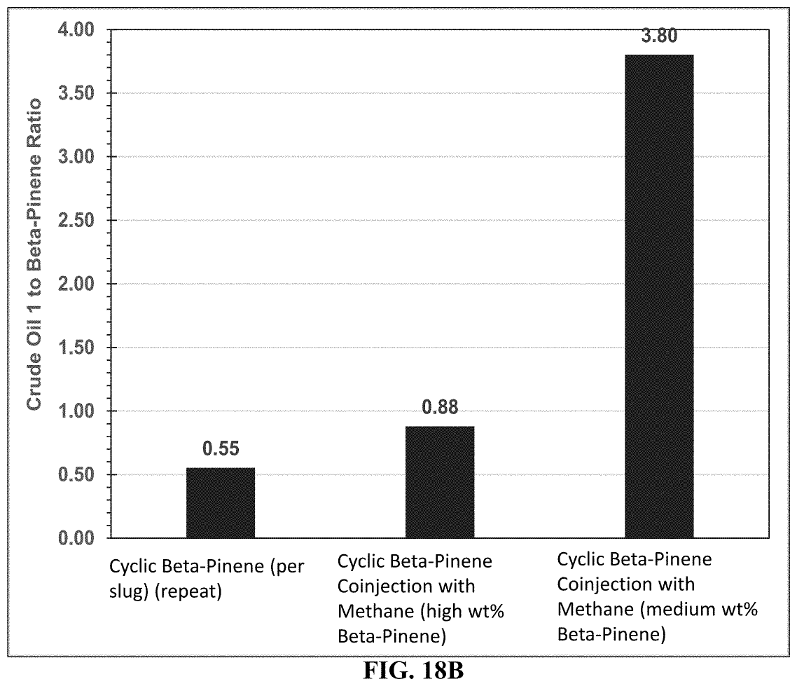

Example 8: FIG. 18A illustrates simulated cumulative oil production for Crude Oil 1 after cyclic beta-pinene injection. Numerical simulation illustrates that cyclic beta-pinene injection with no steam could produce more oil than conventional cyclic steaming when slug sizes are kept the same. This numerical simulation did not include the injection of any additives, but it is expected that injection of one or more additives will not negatively impact the simulation in a substantial manner based on the results illustrated in FIGS. 17A-17B. The numerical simulation utilized methane for simplicity, but carbon dioxide could have been utilized. FIG. 18B provides more details regarding the numerical simulation.

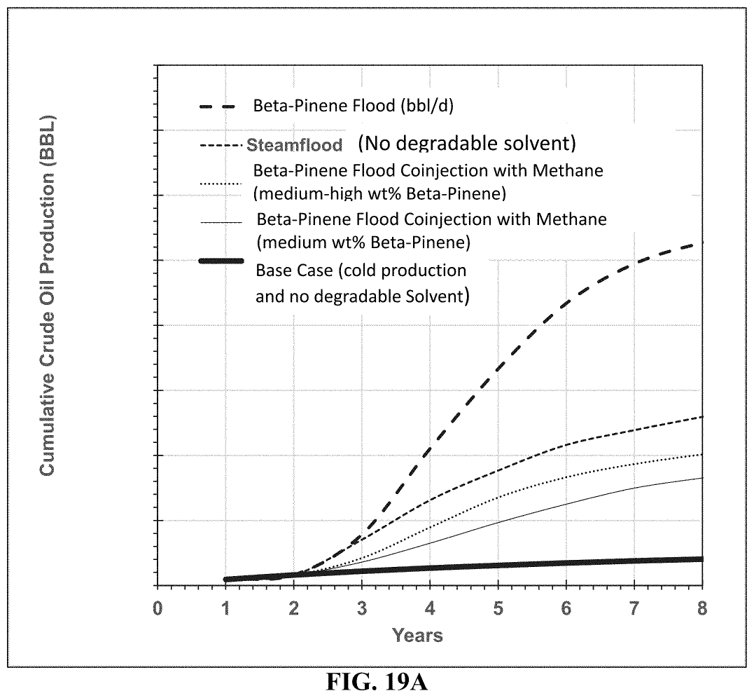

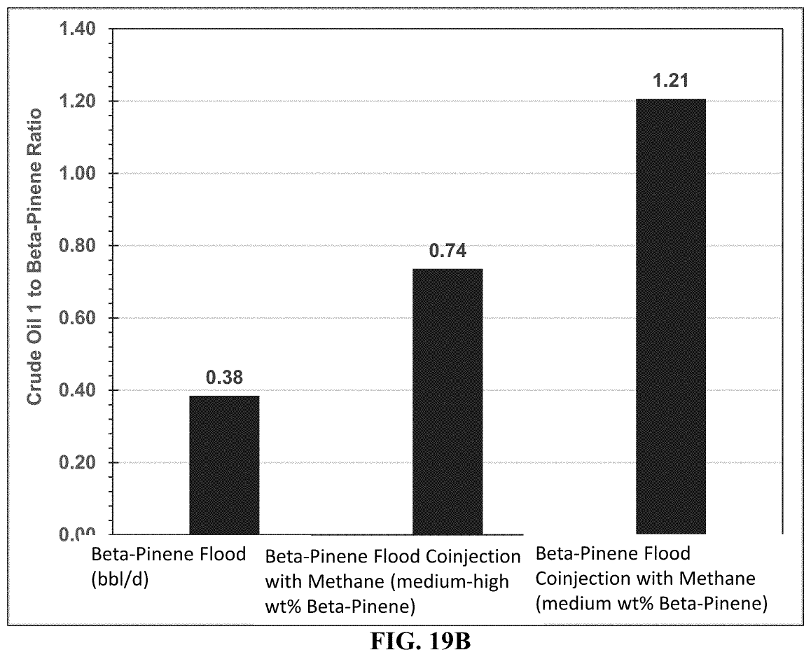

FIG. 18B illustrates simulated Crude Oil 1 to beta-pinene ratios for cyclic solvent injection with and without methane co-injection. Solvent losses could be expensive. However, numerical simulation illustrates that the co-injection of a non-condensable gas, such as methane, during cyclic solvent injection using the degradable solvent beta-pinene could increase the oil-to-solvent ratio from 0.55 to 3.8. In FIGS. 18A-18B and 19A-19B, the term high refers to 91% to 99%, the term medium-high refers to 71% to 90%, and the term medium refers to 50% to 70%.

Example 9: FIG. 19A illustrates simulated cumulative oil production for Crude Oil 1 after beta-pinene flooding. Numerical simulation illustrates that beta-pinene flooding could produce more oil than any other illustrated method. This numerical simulation did not include the injection of any additives, but it is expected that injection of one or more additives will not negatively impact the simulation in a substantial manner based on the results illustrated in FIG. 17. The numerical simulation utilized methane for simplicity, but carbon dioxide could have been utilized. FIG. 19B provides more details regarding the numerical simulation.

FIG. 19B illustrates simulated Crude Oil 1 to beta-pinene ratios for solvent flooding with and without methane co-injection. Solvent losses could be expensive. However, numerical simulation illustrates that the co-injection of a non-condensable gas, such as methane, during flooding using the degradable solvent beta-pinene could increase the oil-to-solvent ratio from 0.38 to 1.21.

Of note, in FIGS. 18A-18B and 19A-19B, the term high refers to 91% to 99%, the term medium-high refers to 71% to 90%, and the term medium refers to 50% to 70%.

Example 10: FIGS. 20A-20B illustrates the effect of degradable solvents on asphaltene stability in laboratory experiments as measured using ASTM D6703-19 at 25° C. In general, heavy hydrocarbon is an asphaltene-containing liquid crude hydrocarbon and asphaltenes are present in relatively large quantities in heavy crude oils. Asphaltene precipitation typically leads to asphaltene deposits in wellbores, surface facilities, and conduits such as pipelines. Asphaltene deposits are typically undesirable because they can cause clogging in conduits, equipment issues such as pump failures at a surface facility and heat exchanger fouling at refineries, etc., which in turn leads to repair and/or replacement of the affected items along with the associated expense and downtime. Asphaltene precipitation can be significant in many EOR processes and many techniques have been utilized to address asphaltene precipitation such as those described in U.S. Pat. No. 10,975,291, which is incorporated by reference. In short, stable asphaltenes are desirable to reduce or avoid asphaltene precipitation and the associated issues such as clogging, repairs, replacements, etc.

ASTM D6703-19 was used to generate the asphaltene stability measurements in terms of P-values as illustrated in FIGS. 20A-20B. In FIG. 20A, seven samples were prepared by adding the degradable solvent d-limonene at varying wt. % (from 10 wt. % to 90 wt. %) to Crude Oil 1. Similarly, in FIG. 20B, seven samples were prepared by adding the degradable solvent beta-pinene at varying wt. % (from 0 wt. % to 100 wt. %) to Crude Oil 1. A P-value of 1.2 was utilized as the stability limit for the asphaltenes for the samples such that asphaltene precipitation is likely to result below the P-value of 1.2, but asphaltene precipitation is not likely to result at a P-value of 1.2 or more.

Surprisingly, the addition of the degradable solvent d-limonene in FIG. 20A and beta-pinene in FIG. 20B led to stable blends with P-values above 2.5 (including many P-values above 3.0) using the stability limit of 1.2. In other words, surprisingly, the degradable solvents d-limonene and beta-pinene generally kept the asphaltenes stable in the Crude Oil 1 samples of FIGS. 20A-20B without any dedicated effort to keep the asphaltenes stable. FIG. 21 is an image from one of the laboratory experiments illustrating that the asphaltenes are stable in solution. Without wishing to be bound by theory, it is believed that based on the results in FIGS. 11-17 and 20A-20B, for Crude Oils 1 and 2, the addition of small quantities of degradable solvents (e.g., <10%), such as d-limonene and beta-pinene, led to viscosity reductions in the order of 70-90% and 60-80% at 40° C. and 100° C., respectively, without substantially affecting asphaltene stability. Indeed, without wishing to be bound by theory, it is believed that these results in FIGS. 20A-20B illustrate that degradable solvents, such as d-limonene and beta-pinene, may be utilized to maintain asphaltenes stability as well as to decrease the viscosity and increase the API Gravity of heavy hydrocarbon as in FIGS. 11-17. Thus, FIGS. 11-17 and 20A-20B illustrate some of the potential advantages of using degradable solvents for enhanced oil recovery (EOR) of heavy hydrocarbon.

Table 2 below illustrates the asphaltene solubility in different solvents. Aromatics such as toluene and xylene are very effective solvents for asphaltenes, whereas paraffins (pentane and hexane) are not. In addition, cycloparaffins (naphthenes) such as cyclopentane and cyclohexane have medium solvent power for asphaltenes. Surprisingly, degradable solvents such as limonene and pinene (from the terpene family) may be utilized as asphaltene solvents as described hereinabove.

| Solvent | Asphaltene Solubility |
|---|---|
| Toluene | High |
| Xylene | High |
| Pentane | Low |
| Hexane | Low |
| Cyclopentane | Medium |
| Cyclohexane | Medium |
| D-Limonene | High |
| (Degradable) | |
| Beta-Pinene | High |
| (Degradable) | |

Example 11: A vertical well was drilled into a reservoir having heavy hydrocarbon at a depth of about 2100 ft using a conventional water-based drilling mud. After that, 120 bbl (5,040 gals) of detergent-containing water (2 wt. % of dodecyl benzene sulfonate) was recirculated to clean the well. After that, 30 bbl (1260 Gal) of a degradable solvent in the form of a filtered hydrotreated mineral oil (glass filtration media for 0.5 microns) containing 0.5 wt. % lecithin (wettability agent) was used to displace the water-based fluid in the well. After that, 30 bbl (1260 Gal) of the same degradable solvent was used for flushing out the filtered mineral oil-lecithin solution. The well was left untouched for several weeks. After that, a fluid sample was taken. The fluid sample included a significant amount of dust particles and debris due to normal well conditions and small droplets of water/oil emulsions were observed. Also, the copper-containing tubing was covered with a black sulfate layer indicating the presence of sulfate-reducing bacteria. Without wishing to be bound by theory, it is believed that the use of one or more detergents, one or more demulsifiers, one or more scavengers, one or more biocides, or any combination thereof can be utilized to control the observed dust particles and debris, small droplets of water/oil emulsions, and black sulfate layer indicating the presence of sulfate-reducing bacteria associated with the degradable solvent injection in Example 11. Example 11 is an actual field test, not a simulation and not a model.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for in situ upgrading of a heavy hydrocarbon in a reservoir having an injection well and a production well, or a well that is alternately operated as an injection well and a production well, the method comprising:
injecting one or more degradable solvents and one or more additives into the injection well in the reservoir comprising the heavy hydrocarbon so as to form a blend in the reservoir that comprises an upgraded hydrocarbon,
wherein the upgraded hydrocarbon has an API gravity greater than an initial API gravity of the heavy hydrocarbon and a viscosity lower than an initial viscosity of the heavy hydrocarbon, and
wherein the one or more additives comprise one or more detergents, one or more demulsifiers, one or more scavengers, one or more biocides, or any combination thereof.

2. The method of claim 1, further comprising co-injecting one or more non-condensable gases with the one or more degradable solvents.

3. The method of claim 2, wherein the one or more non-condensable gases comprise carbon dioxide, methane, or any combination thereof.

4. The method of claim 1, further comprising producing the blend comprising the upgraded hydrocarbon from the production well.

5. The method of claim 4, further comprising:
removing at least a portion of the upgraded hydrocarbon from the produced blend, wherein the removed upgraded hydrocarbon comprises at least a portion of the one or more degradable solvents injected into the injection well; and
injecting the removed upgraded hydrocarbon into the injection well, a different injection well, or any combination thereof.

6. The method of claim 4, wherein the produced blend further comprises at least a portion of the one or more degradable solvents injected into the injection well; and
further comprising removing at least a portion of the one or more degradable solvents from the produced blend and injecting the removed one or more degradable solvents into the injection well, a different injection well, or any combination thereof.

7. The method of claim 1, wherein each degradable solvent has an aromatic content of from less than 1% wt./wt. as measured by ASTM D6591-19.

8. The method of claim 1, wherein each degradable solvent has an asphaltene stability P-value of from 1.2 or greater as measured by ASTM D6703-19.

9. The method of claim 1, wherein incubated at reservoir temperature in contact with reservoir water for 60 days, less than 25% of each degradable solvent remains as measured by gas chromatography.

10. The method of claim 1, wherein eradiated with artificial sunlight at reservoir temperature in contact with reservoir water for 60 days, less than 25% of each degradable solvent remains as measured by gas chromatography.

11. The method of claim 1, wherein less than 25% of each degradable solvent remains as measured by ASTM D6139-18, ASTM D5864-18, ASTM D6731-18, or any combination thereof at reservoir temperature in contact with reservoir water for 60 days.

12. The method of claim 1, wherein the one or more degradable solvents have a total viscosity of 10 centistokes or less measured at 40° C.

13. The method of claim 1, wherein the one or more degradable solvents are injected into the reservoir at a ratio by volume of the one or more degradable solvents to upgraded hydrocarbon produced of from 0.05:1 to 0.15:1.

14. The method of claim 1, wherein the one or more degradable solvents comprise a substituted cycloalkene, an unsaturated cyclohexyl ring, C₈-C₁₂ carbon atoms, or any combination thereof.

15. The method of claim 1, wherein the one or more degradable solvents comprise one or more terpenes.

16. The method of claim 15, wherein the one or more terpenes comprise a plant-derived terpene, a bio-derived terpene, or any combination thereof.

17. The method of claim 15, wherein the one or more terpenes comprise d-limonene, beta-pinene, myrcene, terpinolene, alpha-farnesene, beta-caryophyllene, nerol, citral, camphor, menthol, geraniol, camphene, squalene, humulene, carvone, linalool, or any combination thereof.

18. The method of claim 1, wherein the one or more degradable solvents comprise one or more mineral oils.

19. The method of claim 18, wherein the one or more mineral oils comprise paraffinic hydrocarbon, naphthenic hydrocarbon, or any combination thereof having carbon numbers of from 15 or more, boiling points in the range of from 300° C. to 600° C., and hydrotreated petroleum distillates with aromatic content of from less than 1 wt. % as measured by ASTM D6591-19.

20. The method of claim 1, wherein the one or more degradable solvents comprise one or more esters.

21. The method of claim 20, wherein the one or more esters comprise a bio-derived ester.

22. The method of claim 20, wherein the one or more esters comprise ethyl lactate, ethyl acetate, methyl acetate, methyl stearate, ethyl stearate, methyl oleate, ethyl oleate, methyl palmitate, ethyl palmitate, methyl linoleate, ethyl linoleate, or any combination thereof.

23. The method of claim 1, wherein the one or more detergents comprise an alkyl benzene sulfonate, an alkyl naphthalene sulfonate, a sulfurized alkylphenol metal salt, or any combination thereof.

24. The method of claim 1, wherein the one or more demulsifiers comprise a polyalkoxylate block copolymer, a polyalkoxylate block ester derivative, an alkylphenol-aldehyde resin with alkoxylate, an alkylphenol-aldehyde resin without alkoxylate, a polyalkoxylate of polyol, a glycidyl ether, or any combination thereof.

25. The method of claim 1, wherein the one or more scavengers comprise an aromatic amine, an alkyl sulfide, a hindered phenol, or any combination thereof.

26. The method of claim 1, wherein the one or more biocides comprise an aldehyde, a quaternary ammonium salt, an amine, a diamine, an isothiazolone, a phosphonium sulfate, or any combination thereof.

27. The method of claim 1, wherein the one or more additives are injected into the reservoir at a ratio by weight of the one or more additives to the one or more degradable solvents of from 10 ppm:1 to 6500 ppm:1.

28. The method of claim 1, wherein the upgraded hydrocarbon has the API gravity greater than the initial API gravity of the heavy hydrocarbon as measured by ASTM D4052-18a.

29. The method of claim 1, wherein the upgraded hydrocarbon has the viscosity lower than the initial viscosity of the heavy hydrocarbon as measured by ASTM D445-19a.

30. A method for selecting a degradable solvent for use in a process for in situ upgrading of a heavy hydrocarbon in a reservoir having an injection well and a production well, or a well that is alternately operated as an injection well and a production well, the method comprising:
selecting the degradable solvent for injection into the reservoir, and wherein the selected degradable solvent satisfies the following criteria:
(a) an aromatic content of from less than 1% wt./wt. as measured by ASTM D6591-19, and
(b) an asphaltene stability P-value of from 1.2 or more as measured by ASTM D6703-19.

31. The method of claim 30, wherein incubated at reservoir temperature in contact with reservoir water for 60 days, less than 25% of the selected degradable solvent remains as measured by gas chromatography.

32. The method of claim 30, wherein eradiated with artificial sunlight at reservoir temperature in contact with reservoir water for 60 days, less than 25% of the selected degradable solvent remains as measured by gas chromatography.

33. The method of claim 30, wherein less than 25% of the selected degradable solvent remains as measured by ASTM D6139-18, ASTM D5864-18, ASTM D6731-18, or any combination thereof at reservoir temperature in contact with reservoir water for 60 days.
